(19) United States
(12) Patent Application Publication
(10) Pub. No.: US 2014/0052503 A1
(43) Pub. Date: Feb. 20, 2014

(54) SYSTEM, TECHNOLOGY, AND METHOD FOR A UNIVERSAL ENERGY EFFICIENCY OPTIMIZATION PLATFORM FOR ENERGY CONSUMING DEVICES, APPLIANCES AND SYSTEMS AT RESIDENTIAL, COMMERCIAL, AND INDUSTRIAL FACILITIES

(71) Applicant: E3 Corporation, Falls Church, VA (US)

(72) Inventor: Joseph A. ZALOOM, Arlington, VA (US)

(73) Assignee: E3 Corporation, Falls Church, VA (US)

(21) Appl. No.: 14/065,179

(22) Filed: Oct. 28, 2013

Related U.S. Application Data
(63) Continuation-in-part of application No. 13/452,819, filed on Apr. 20, 2012, now Pat. No. 8,571,922.
(60) Provisional application No. 61/477,956, filed on Apr. 21, 2011.

(51) Int. Cl. G06Q 10/06

(52) U.S. Cl. CPC G06Q 10/06393
USPC 705/7.39

(57) ABSTRACT

A computer implemented system and method for optimizing the operating and financial efficiency of any energy consuming device, from a desk lamp to a major industrial chiller, by profiling its current, or recent, energy use in comparison to its own select recent or historical energy use baseline, monetizing the difference in energy use, and then transforming the information into actionable insight by contextualizing it in light of the device's own design operating parameters, hours of operation, and other relevant factors, as well as giving users direct control and scheduling over its operations for optimum operating and financial efficiency.

### CROSS-REFERENCE TO RELATED APPLICATIONS

This application is a continuation-in-part of U.S. patent application Ser. No. 13/452,819 filed Apr. 20, 2012, now U.S. Pat. No. 8,571,922 issued Oct. 29, 2013, which claims the benefit of U.S. Provisional Patent Application No. 61/477,956 filed Apr. 21, 2011. The disclosures of the prior applications are incorporated herein in their entirety by reference.

### STATEMENT REGARDING FEDERALLY SPONSORED RESEARCH OR DEVELOPMENT

None.

### FIELD

This technology relates to a method and system for the ongoing analysis, assessment and enhancement of the operating and financial performance of energy and water consuming devices, appliances, and systems at residential and commercial facilities of any size, function, and type, and particularly the consumption of electricity at commercial, institutional, and industrial facilities.

### BRIEF DESCRIPTION OF DRAWINGS SHOWING EXAMPLE NON-LIMITING EMBODIMENTS

FIG. 1 shows an example non-limiting computer implemented method and system which may consist of up to five steps whose combined functionality provides for the quick enhancement of the operating and financial performance of any device, appliance, system, home, or facility.

FIG. 2 shows example system components used to implement the method of FIG. 1.

FIG. 3A and FIG. 3B illustrate an overview of the system and method of FIG. 1 and FIG. 2 using a non-limiting example of the implementation of such a system and method for a typical household.

FIGS. 4A-4D illustrate various possible embodiments for conventional Sub-Metering and Control “M&C” modules.

FIG. 5 illustrates an embodiment for a Data Collection and Device Control “DC&DC” appliance.

FIG. 6 illustrates the components of the Universal Data Collection, Control, Analytics, and Community “UCC” website; how the data is compartmentalized by participating household or facility, and how the data for each participant may be further compartmentalized by type of data and function.

FIG. 7 is a schematic flow diagram of the process involved in connecting a device, appliance, or equipment to an M&C module, establishing an account on the UCC website, and beginning to monitor and control the attached device from web-enabled computing device, using a specialized application referred to as the “Logical Efficiency Optimizer” or (“LEO”) App.

FIG. 8 illustrates a non-limiting example overview of the type of data that may be collected and the type of settings that may be established during a new account setup on the UCC website.

FIG. 9 illustrates a non-limiting embodiment of the main sections of the LEO App.

FIG. 10 illustrates a non-limiting embodiment of the use of strategically located icons in the LEO App. to help control the user's viewing experience and to provide access to the account setup area of the UCC website.

FIG. 11 illustrates a non-limiting example of the various components that may be part of the Data Center in the LEO App.

FIG. 12A-12-D illustrate the various components of the data Selection Panel in the LEO App.

FIG. 13 illustrates the various components of the Display Panel.

FIG. 14 illustrates a non-limiting example of the various components that may be part of the Knowledge Center.

FIG. 15 illustrates the various components of the Control Center.

FIG. 16 provides close-up visual examples of the synchronization, visualization, quantification, and monetization methods for analyzing the operating performance of a device in 2-hour increments.

FIG. 17 provides close-up visual examples of the synchronization, visualization, quantification, and monetization methods for analyzing the operating performance of a device in 1-hour increments.

FIG. 18 provides close-up visual examples of the synchronization, visualization, quantification, and monetization methods for analyzing the operating performance of a device in weekly increments.

FIG. 19 provides close-up visual examples of the synchronization, visualization, quantification, and monetization methods for analyzing the operating performance of a device in monthly increments.

FIG. 20 provides close-up visual examples of the synchronization, visualization, quantification, and monetization methods for analyzing the operating performance of a device in yearly increments.

FIG. 21 provides an example non-limiting view of the LEO App. interface illustrating selected devices load profiles in Day view, visualized in 2-hour increments, and displaying a log entry in the Logs category of the Knowledge Center.

FIG. 22 provides an example non-limiting view of the LEO App. interface illustrating selected devices load profiles in Day view, visualized in 1-hour increments, and displaying device information in the information category of the Knowledge Center.

FIG. 23 provides an example non-limiting view of the LEO App. interface illustrating selected devices load profiles in Day view, visualized in 2-hour increments, and displaying device information in the information category of the Knowledge Center.

FIG. 24 provides an example non-limiting view of the LEO App. interface illustrating selected devices load profiles in Day view, visualized in 2-hour increments, and displaying document links in the Documents category of the Knowledge Center.

FIG. 25 provides an example non-limiting view of the LEO App. interface illustrating selected devices load profiles in Day view, visualized in 2-hour increments, and displaying links in the Community category of the Knowledge Center.

FIG. 26 provides an example non-limiting view of the LEO App. interface illustrating selected devices load profiles in the Week view.

FIG. 27 provides an example non-limiting view of the LEO App. interface illustrating selected devices load profiles in the Month view.

FIG. 28 provides an example non-limiting view of the LEO App. interface illustrating selected devices load profiles in the Year view.

FIG. 29 shows an example non-limiting universal data collection, control, analytics, and community website platform architecture.

FIG. 30 shows an example non-limiting logical efficiency optimizer application interface structure.

### DETAILED DESCRIPTION OF NON-LIMITING EXAMPLE EMBODIMENTS

Cutting energy waste is first and foremost a data challenge. You can't cut waste until you know what you are wasting. Yet, most of us have only the slightest idea. Standard energy meters take one reading for an entire month. Even the latest and most advanced smart meters, which have the capability to measure energy consumption in 1-second increments, are typically underutilized and used to report the overall energy profile of a home or facility. This makes it impossible to figure out how each device, appliance, or equipment is performing with respect to the overall use of energy at that home or facility.

Furthermore, comparing a home or a facility's use of energy to neighboring facilities generally offers little insight whatsoever as to the actual performance of the home or facility. Two same size 2-bedroom apartments in a building complex can have radically different consumption patterns from one another if one apartment houses a childless retired couple that rarely entertains at home and the other has two young children and a baby. The same goes for commercial buildings; even commercial buildings that are identical in size, function, and number of employees will have different energy profiles if one building operates on longer hours each week than the other.

The example non-limiting technology herein makes use of new metering and wireless communications technologies to overcome the deficiencies of the prior art by providing an integrated approach that can optimize the operating and financial efficiency of any energy consuming device, from a desk lamp to a major industrial chiller, by visualizing its current, or recent, energy use in comparison to its own select recent or historical energy use baseline, quantifying and monetizing the difference in energy use, and then transforming that information into actionable insight by contextualizing it in light of the device's own design operating parameters, hours of operation, and other relevant factors, and giving users direct control and scheduling over its operations for optimum operating and financial efficiency.

The example non-limiting technology herein can be used to bypass the traditional use of “big data analytics” to crunch energy users' consumption data to discover common patterns by enabling energy users to transmit their consumption performance to a central database where it can be instantly tallied anonymously against the performance of other users by household/organization, home/facility location, size, function, number of occupants and other relevant parameters.

The example non-limiting technology can be applied equally to any device, appliance, and system which is sub-metered individually as well as to the consumption of energy at homes and facilities overall. In fact, the best use may be to apply it, both, to the overall energy consumption of a given home or facility as well as to individual devices, appliances, and systems within the home or facility, whose energy consumption is of interest to the user.

Furthermore, example embodiments relate to the use of electricity in a home or a facility. However, the method of this invention can be applied equally to the use of any source of energy, and even to the use of water, provided that the consumption of the subject commodity is metered in specific, small, time increments.

My previous disclosure (incorporated herein by reference) provided algorithmic methods and systems for conserving energy and/or other resources through the ongoing analysis, assessment and enhancement of the operating and financial performance of energy and water consuming systems at large facilities. Recent advances in smart meters and other consumer related metering technology, widespread availability of WiFi-enabled programmable appliances, switches, and controllers, and increased bandwidth of common household Ethernet switches and routers have eliminated previous metering limitations to create additional opportunities.

The new emerging technologies make it no longer necessary to wait 30 days for the metering data to be available from the utility companies. The data can now be available almost instantly for any device, and it is no longer necessary to limit the measurement of energy use to 15-minute intervals. New meters can now provide energy use measurements in 1-second intervals or the like. As a result, performance analysis is no longer limited to measurements across 364 days; it can now be measured, across days, hours, and even minutes. Furthermore, it is no longer necessary to display energy performance in weekly increments, except for weekly, monthly or annual evaluations. Performance is now best displayed and analyzed for any device, appliance, equipment—or for the overall facility or home—on a daily or even more frequent basis. Furthermore, it is no longer necessary to use traditional “big data analytics” to crunch energy users' consumption data to discover common patterns. The emerging technologies described above enable energy users not only to view, measure, quantify, monetize, diagnose, document, and control their energy consumption individually by device, but they also enable them to transmit their consumption performance to a central database where it can be instantly tallied anonymously against the performance of other users by household/organization, home/facility location, size, function, number of occupants—and for household users, energy consumption, price, and cost, can be tallied by a plethora of additional factors such as occupation, income level, number of children, and other parameters.

By enabling users to measure their energy performance across days, hours, and minutes—almost instantly, the new technologies described above enable users to find out not only when an unusual deviation in their energy consumption happened, but also to determine what happened, to isolate the device, appliance, or system that caused the deviation, to diagnose and document why the deviation happened, to determine how much it cost, or how much it saved, and to take immediate action if necessary.

A variety of systems technologies and methods are currently on the market that provide residential and commercial energy users with a level of motivation to save energy and provide them with some control over their energy efficiency. These systems, technologies, and methods may typically and generally fall into two categories; the motivational approach, and the automated energy efficiency approach.

The motivational approach relies on comparing the energy consumption of one's home or facility to a group of nearby households and facilities, comparing the energy consumption level of each home or facility to the overall consumption of the group, and ranking the individual consumers' monthly consumption to that of other neighboring homes or facilities (i.e., whether their consumption is average, below average, or above average in comparison to the other facilities in the group). The concept is that providing such comparisons on a monthly basis will spur a spirit of competitiveness among energy users that will result in behavioral changes that will improve the energy efficiency of participating homes and facilities. In the home market, this approach was pioneered by Opower (www.opower.com). Opower categorizes its approach as “Behavioral Energy Efficiency” and “Behavioral Demand Response”. It has recently been joined in its efforts by Nest (www.nest.com) which acquired MyEnergy (www.myenergy.com); a prior competitor to Opower.

In the commercial market, this approach is exemplified by the so called “Dashboards” that provide participants real-time feedback on their energy consumption in comparison to other nearby facilities in order to drive behavioral changes and improves operational efficiency. A number of companies provide such a service. Two of the most prominent ones are Lucid (www.luciddesigngroup.com) and Periscope (www.periscopedashboard.com). Dashboard companies tend to focus primarily on institutions that have campuses such as universities, colleges, schools, and museums because these institutions typically own or manage a large number of nearby facilities that can be made to “compete” against one another for improved energy efficiency.

The automated energy efficiency approach is primarily focused on the home market. It relies on handing the controls of the home thermostat, which typically controls half of a household's energy needs, to a “smart” thermostat which is programmed to learn the comfort habits of the home occupants and schedule its operations accordingly. The home users are typically left out of the thermostat's decision making process and have no idea of its workings. However, they are given the ability to over-ride its schedule of operations manually. The main players in this market are Nest (www.nest.com), Vivint (www.vivint.com), and Honeywell (www.honeywell.com). Opower (www.opower.com) recently partnered with Honeywell to bring that capability to their customers, and Vivint, which is also a home security and home automation company now includes smart thermostats and solar panels in its offerings.

While the methods and approaches discussed above do provide a level of behavioral enthusiasm and control over a user's energy efficiency, they consist of fragmented methods that generally offer no insight as to what is driving an increase or decrease in consumption at a home or business facility and how a user's specific actions or behavioral changes have impacted his or her energy bills. They offer few or no diagnostics or documentation capabilities—and more importantly, for most users, energy efficiency continues to be an abstract concept which is the province of energy managers, in the commercial market, and of smart thermostats, in the residential market. These limitations substantially restrict the average energy user's ability to take intelligent and meaningful actions to eliminate waste and cut costs.

Therefore, a need exists for a comprehensive, integrated approach that can optimize the operating and financial efficiency of any energy consuming device, from a desk lamp to a major industrial chiller, by transforming energy efficiency from an abstract concept into something tangible that any energy user can easily understand and relate to, and by providing users with insight into what is driving their energy consumption and costs, and giving them direct control over their various devices and equipment from a single, integrated, simple, and fun application that can be accessed from any web-enabled computing device, anytime, anywhere, in the World.

I would like to expand on the meaning, power and value of the techniques introduced in this patent application; specifically as it relates to the optimization of the daily consumption of energy:

Current industry energy management practices for assisting users in optimizing their energy consumption and costs essentially revolve around two techniques:
1. Providing, mainly commercial users, with the real-time, recent, and historical energy profile of their facilities on a daily basis, and when available, comparing the energy profile of their buildings with that of neighboring facilities.
2. Providing commercial users, and residential users with advanced metering technology, their daily average, high, and low consumption for each day of the month.

While these techniques do offer certain advantages over standard energy meters which provide only a single reading for the entire month, they nevertheless do not provide the energy user with any insight regarding their home or facility's energy performance. For example, they do not provide any indication or insight on whether a substantial decrease in energy consumption from the prior month was due to changes in operations, weather, or an electrical or mechanical malfunction. Nor do they provide any indication or insight as to what exactly contributed to a home or facility's large increase in energy consumption from a prior month, and why. The user is left guessing. Not only that, even if such information were to be made readily available to the user, it would not amount to much enthusiasm or action either; imagine if someone were trying to diet, and all they knew is the amount of calories they ate less from the prior month. For most people, knowing that information would not mean much at all. What most dieting people really care about, is how many pounds they actually lost from the prior month, not how many less calories they ate from the prior month.

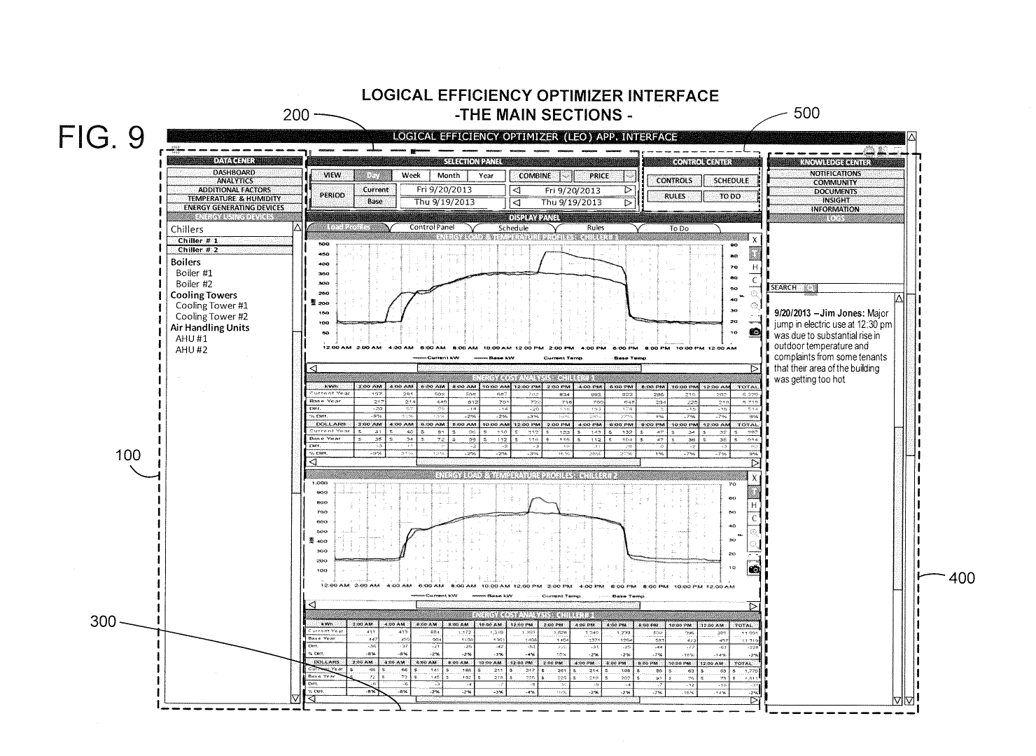

Using the techniques of utilizing inexpensive modern technologies to sub-meter and list energy consumption by device, appliance, or equipment (as listed in the Data Center (100) of FIGS. 9, 10, 11, and 21-28), one can isolate the performance of major energy using equipment with precision and fidelity.

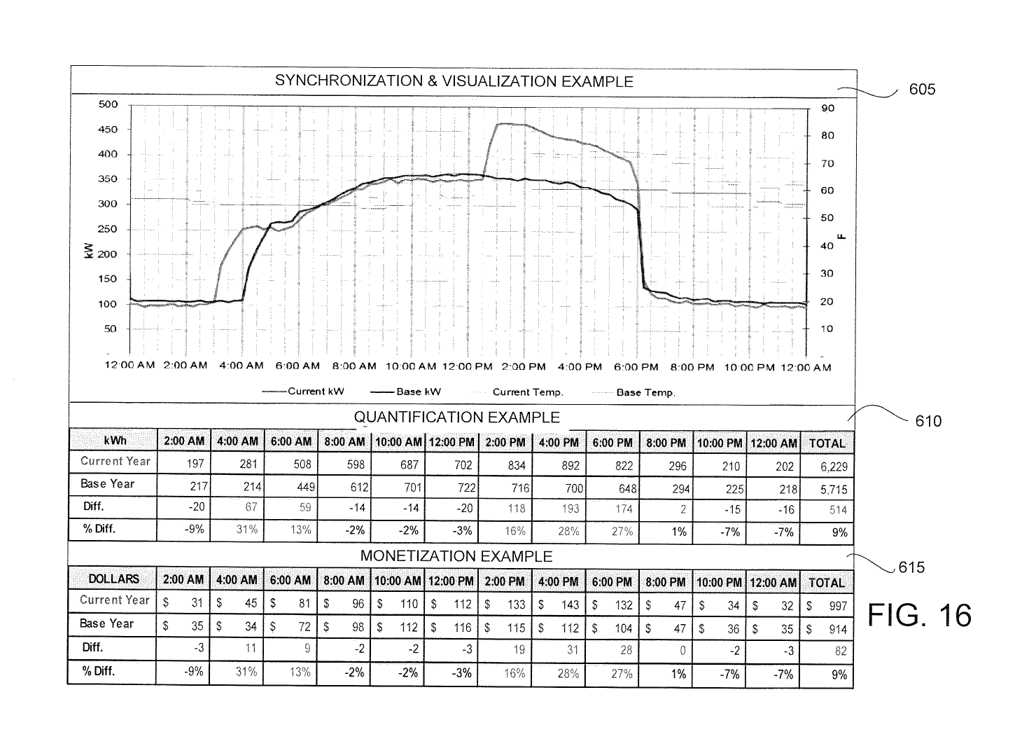

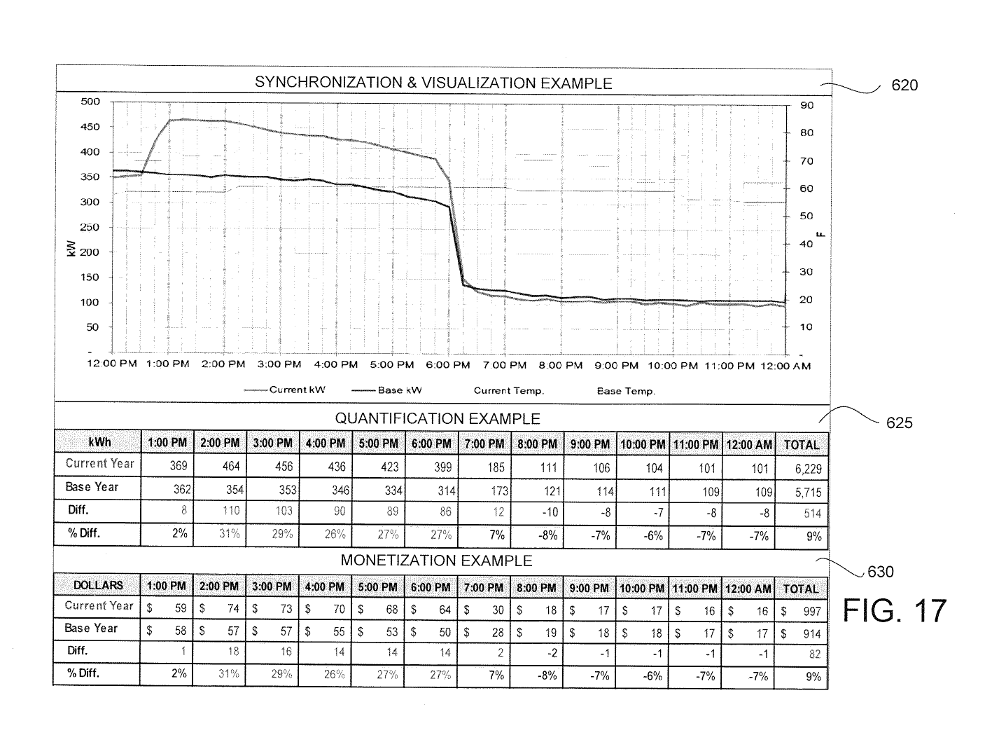

Furthermore, by synchronizing and visualizing current and recent energy consumption with respect to a select recent or historical baseline, one can instantly measure performance against that baseline; it provides meaning to the data. A detailed, real-time energy consumption profile of a building or home, is of very little value in measuring performance because it gives no indication whether such a profile is indicative of a good or bad performance, or an increase or decrease in performance. For example, suppose two homes are built exactly the same, with exactly the same equipment and furnishings; inhabited by same number of people of exactly the same age, occupation, and social habits, yet in one home the adult people go to work, and in the other home, the adult people run a business from their home. In this case, it would be of little value simply to visualize the real-time energy profile of each home—and even more so, to compare the two homes together. In fact, using “big data analytics” the family where the people run a business from their home will make the energy profile of most neighboring households look good and will likely skew the energy profile of the whole neighborhood. Using the daily synchronization and visualization techniques of FIGS. 9, 10, 13, 16, 17, 18, and 21-25) valuable insights may be gained; for example, looking at the synchronization and visualization graph (605) of FIG. 16, one can tell that the increase in energy consumption in the “Current Year” profile (which could be any day in the current year) from the “Base Year” profile (which could also be any day in the current year, or a prior year), increased in the early afternoon, most likely due to a sudden increase in the temperature profile of the “Current Year” profile over the temperature profile of the base year. Furthermore, by examining the quantification example table (610) of FIG. 16, one can tell that energy consumption increased 16% over the base year between noon and 2:00 pm, then 28% between 2:00 pm and 4:00 pm, and then 27% between 4:00 pm and 6:00 pm before going back to normal around 6:00 pm. Looking further into the Monetization Example (615) of FIG. 16, one can tell that the 16% increase in energy use between noon and 2:00 pm cost $19, while the 28% increase in energy use between 2:00 pm and 4:00 pm cost $31, and the increase in energy use between 4:00 pm and 6:00 pm cost $28, for a total cost increase of $78. That means, that whatever action was taken in the afternoon; likely to keep up with the increasing temperature, cost the facility $78. Looking further into the data by zooming in the time interval into 1-hour intervals, as illustrated in the synchronization and visualization example (620) of FIG. 17, one can delve deeper into the cost of energy increase, each hour, between the hours of noon and 7:00 pm. This is a very powerful feature for two important reasons:
1. By monetizing the amount of energy increase, energy is instantly transformed from an abstract concept into a tangible value that anyone can understand and relate to.
2. This feature enables users to quickly measure the energy efficiency of any new device, technology, or any change in operation in dollars—in a matter of hours. For example, by quantifying and monetizing energy use from a baseline, a person can replace an incandescent desk lamp with an LED lamp, and within minutes, find out exactly how much the new LED lamp is saving by the minute, hour, day, month, and year. One can figure out the cost of the “Dry” cycle of a dishwasher, by comparing the cost of washing the dishes with the “Dry” cycle in the “On” setting, versus with the dishwasher with the “Dry” cycle in the “Off” setting. One can compare the cost of maintaining a home at 78 Degree Fahrenheit in the summer versus 72 Degrees Fahrenheit. The same concept applies to in a commercial setting. Using the same approach, an organization can measure the cost of running the building an extra one hour each day, or measure exactly how much it cost to run certain areas of the building after hours or on weekends.

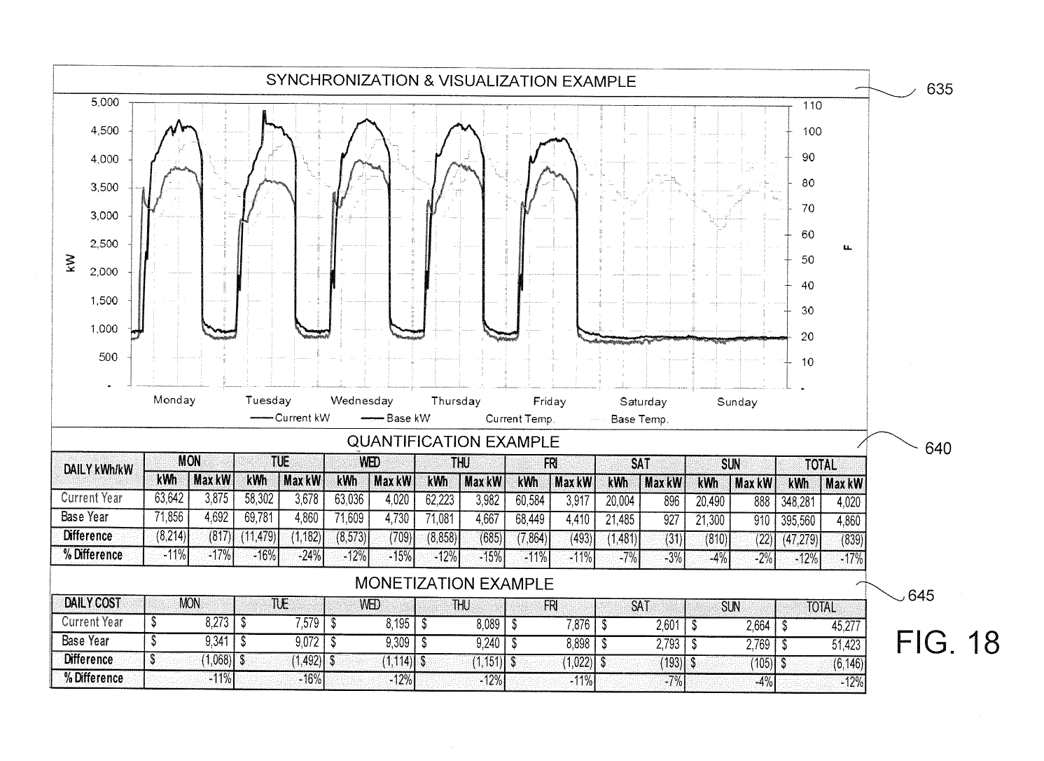

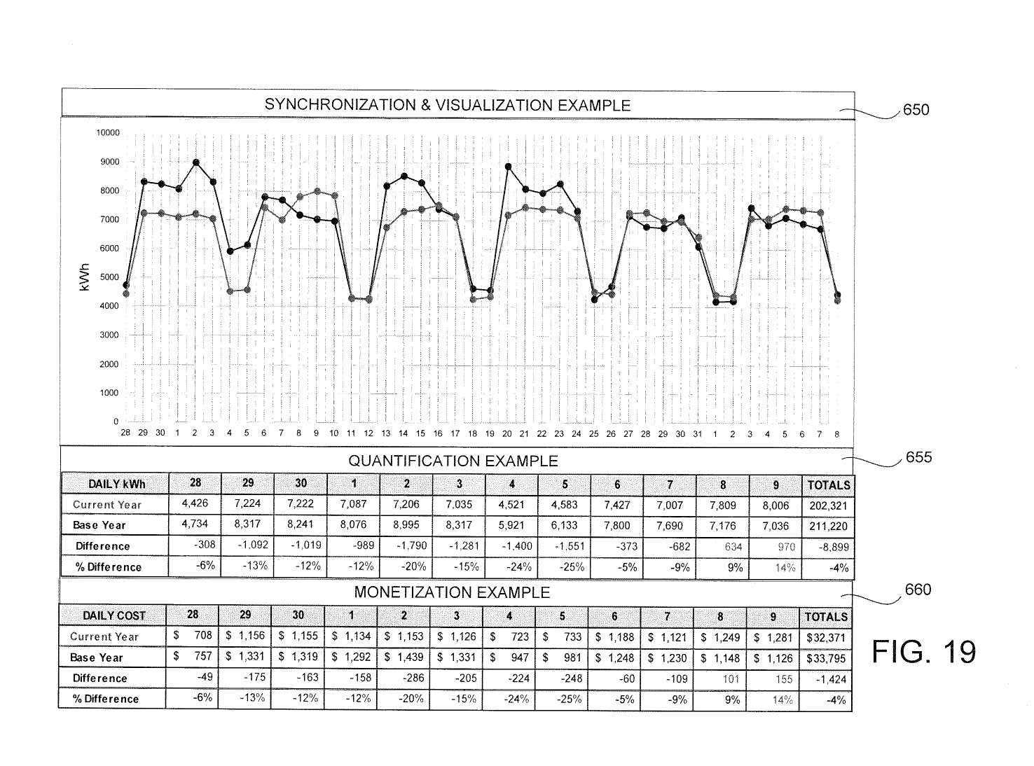

While measuring the cost of energy operations by the hour and by the day is very useful and powerful concept in and of itself, it is often desirable, especially in a commercial setting, to review daily performance in a weekly and monthly context. That is why the synchronization, visualization, quantification, and monetization techniques of FIG. 18 and FIG. 19 can also be very useful.

While measuring and monetizing current or recent energy consumption against a baseline is a very powerful concept, it is not sufficient in and of itself—especially in a commercial or industrial setting where energy managers need to optimize the operating performance of a multitude of equipment and facilities. That is why some of the information provided in the Knowledge Center (400) is absolutely essential for transforming the visualized and monetized information displayed in FIGS. 9, 10, 13, and 16-28 into insight. Not knowing the name plate and design operating parameters of a machine whose performance is being visualized and monetized in the Display Panel is like having a doctor examine a patient without knowing anything about his personal and family's medical history. Furthermore, not having an operations log (405) to document and reference earlier consumption irregularities is like going to a doctor who does not document the symptoms and diagnoses of his patients' visits. Also, not having a log for documenting learned insight (409), is like never learning from one's experiences and mistakes; the insight category is essential for remembering which solutions worked, and which did not, and why some solutions worked and why others did not.

Additionally, even the best insight, if not acted upon, is useless—and there is a big distance between knowing what is good for you and acting upon it—especially in a commercial setting with a multitude of machines and controls. That is why the control center (500) shown in FIGS. 9, 10, 15, and 21-28 is essential for an efficient integrated solution. It is like having a gym at home. While most people know that exercising is good for them, most people do not have the time or the extra energy and motivation it takes to go to a gym and exercise on a regular basis. Having a gym or an exercise machine at home would make a big difference whether action is taken or not. In fact, the Control Center (500) is an integral part of the method of this invention and at the heart of the concept of the Logical Efficiency Optimizer (LEO) software. It enables energy users to quickly and intelligently recalibrate their operations in light of insight learned from the Knowledge Center (400) and provides for the automated provisioning of various operating modes and scenarios.

Finally, all the technological components that are needed to make this a reality are readily available on the market today.

Personal weather stations that take indoor and outdoor temperatures in 5-minute increments or less and that can easily export their data to the system described herein are available from Netatmo (www.Netatmo.com).

Most importantly however, one the major technological components of this invention is the Universal data Collection, Control, Analytics, and Community Website (the “UCC” Website). For this component, Microsoft SharePoint provides the ideal solution. The SharePoint platform would provide a robust, easily configurable and scalable solution for the system and method.

Further example non-limiting advantageous features and advantages of non-limiting technology herein include:

The Synchronization & Visualization methods for: Day, Week, Month

The combination of the synchronization, visualization, quantification, and monetization to transform energy efficiency from an abstract concept to a something tangible that anyone can understand and relate to.

The combination of synchronization, visualization, and quantification with equipment information and operations logs in the Knowledge Center to generate actionable insight.

The combination of monetization (from the display panel), and actionable insights (from the Knowledge Center) with direct control and equipment scheduling in the Control Center to quickly re-calibrate and optimize the operations of any device, appliance, or equipment system.

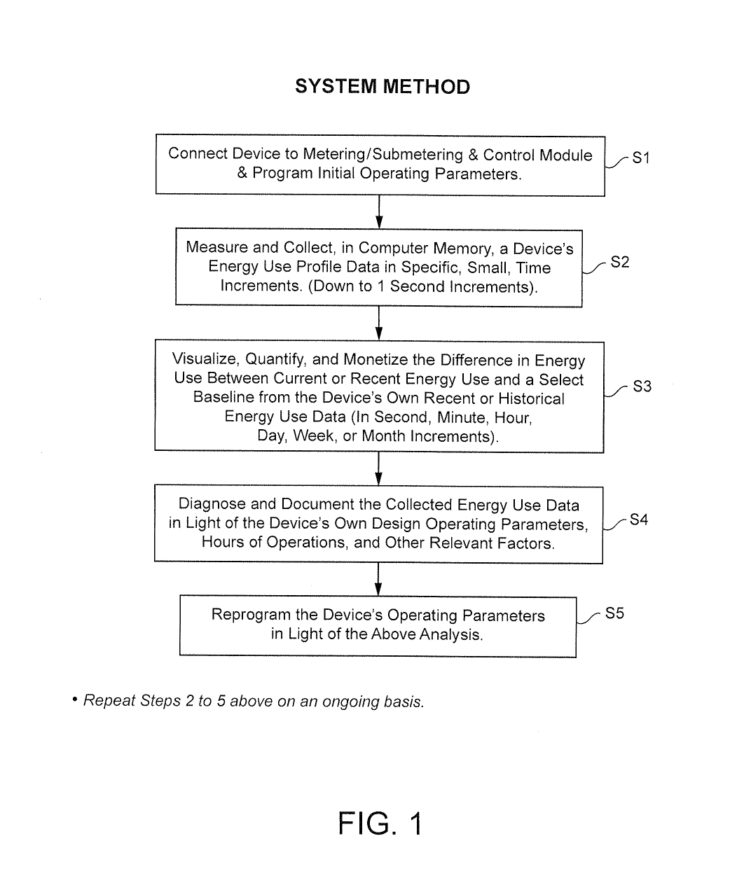

The system method of FIG. 1 (The 5 steps). Basically, the integration of synchronization to a baseline, visualization, quantification, monetization, diagnosis, documentation, and taking or scheduling actions to optimize the operating and financial performance of any device.

The use of the Information and Logs components of the Knowledge Center of the LEO App. in combination with the synchronization and visualization methods described above to enable users to diagnose and document energy consumption and cost.

The layout of the LEO Interface overall; and especially the integration and the location and workings of each section of that interface.

The workings of the LEO Interface, especially the way the sectional tabs drop down when clicked on in the Data Center and the Knowledge Center to open up new areas.

The tabbed display area of the Display Panel that integrates displaying the operating and financial performance of each device with quickly controlling and modifying the schedule of that device.

The zooming in on the operations and costs of each device in the Display Panel.

How the performance of each device can be added and removed from the display panel.

The ability to scroll the display area vertically to see the operation of various devices concurrently.

The ability to scroll the graphic area of each device horizontally in web-enabled devices to move from one period to another sequentially (one day to another, one week to another, one month to another).

The ability to hide and show the Data Center and the Knowledge Center for web-enabled devices.

The ability to instantly expand the viewing of each graph to fill the whole screen.

The Integrated “camera” icon for printing the graphs to a printer or to a PDF file.

The concept of combining the visual performance of select graphs.

The ability to superimpose weather and humidity on each graph.

The ability to select various weather sources in the Data Center.

The use of the Analytics module in the Data Center to instantly list and combine the operating and financial performance of various attached devices in one place.

The use of the Price templates to instantly evaluate costs based on various pricing options. This feature may be used for forecasting and predicting the energy costs of specific actions and available utility pricing options.

The use of the Scheduling feature in the Control Center to verify results of actions taken earlier, by correlating the operations schedule in the Control Center with the operations profile in the Display Panel.

The concept of turning Big Data Analytics on its head, but instantly tallying users' consumption data with detailed, anonymized, personal data from their account profiles to generate powerful insights and rankings on the WCC website instead of the current “big data analytics” of crunching a huge amount of data of a huge number of customers to discern patterns and insights.

### NON-LIMITING EXAMPLES

FIG. 1 relates to a preferred non-limiting embodiment of a computer implemented method and system which may consist of up to five steps whose combined functionality provides for the quick enhancement of the operating and financial performance of any device, appliance, system, home, or facility. The steps in FIG. 1 include: (S1) connect device to metering/sub-metering & control module and program initial operating parameters; (S2) measure and collect, in non-transitory computer memory, a device's energy use profile data in specific, small, time increments (down to 1 second increments); (S3) visualize, quantify, and monetize the difference in energy use between current or recent energy use and a select baseline from the device's own recent or historical energy use data (in second, minute, hour, day, week, or month increments); (S4) diagnose and document the collected energy use data in light of the device's own design operating parameters, hours of operations, and other relevant factors; (S5) reprogram the device's operating parameters in light of the above analysis.

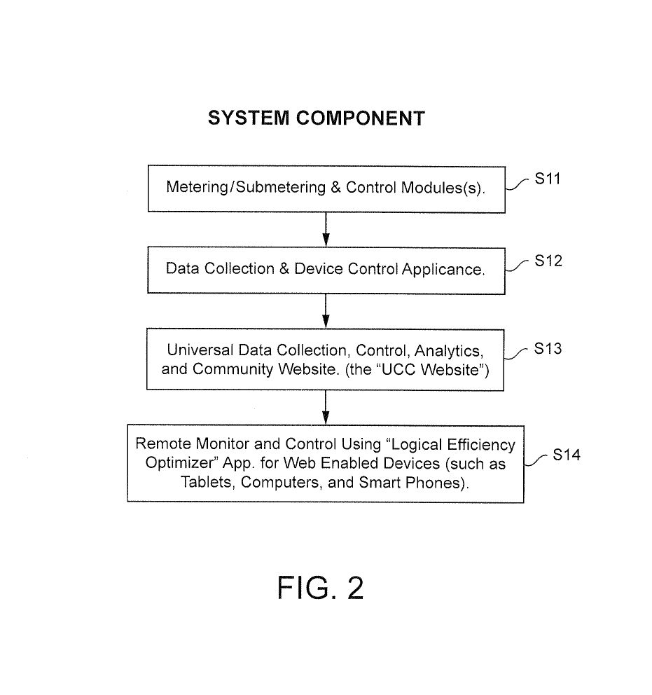

FIG. 2 relates to example non-limiting system components that may be used to implement the method of FIG. 1. The steps in FIG. 2 include: (S11) metering/sub-metering & control module(s); (S12) data collection & device control appliance; (S13) universal data collection, control, analytics, and community website (the “ucc website”); (S14) remote monitor and control using “logical efficiency optimizer” app. for web enabled devices (such as tablets, computers, and smart phones).

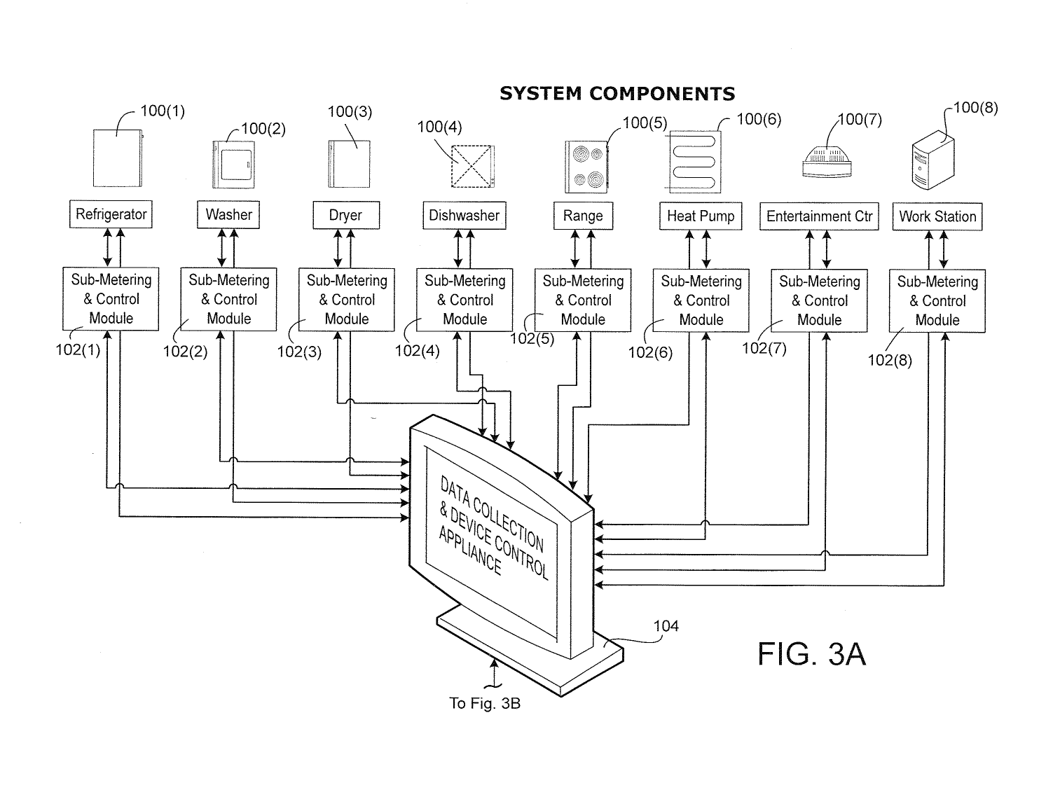

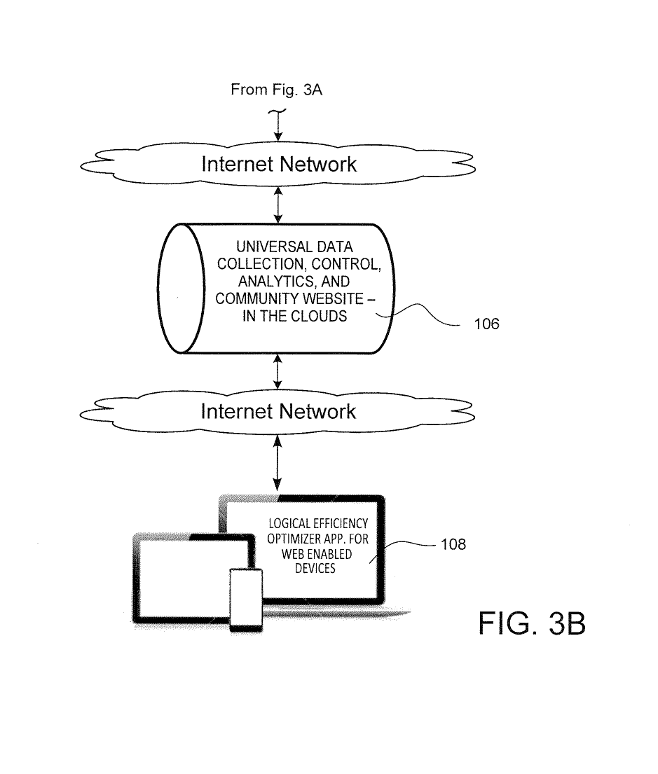

FIG. 3A and FIG. 3B illustrate an overview of the system and method of FIG. 1 and FIG. 2 using a non-limiting example of the implementation of such a system and method for a typical household. FIG. 3A illustrates the flow of information from the displayed household appliances 100(1), . . . 100(n) to a central data collection and device control appliance module 104. Basically, each displayed device or appliance 100(1), . . . 100(n) is connected to respective Metering/Sub-metering & Control (“M&C”) modules 102(1), . . . 102(n) which in turn each measure and transmit the associated device's energy use in specific, small, time increments (down to 1 second increments) to a Data Collection and Device Control (“DC&DC”) appliance 104. M&C modules 102 may also serve as remote On/Off switches for connected devices by turning them “On” or “Off” based on commands issued by the DC&DC appliance. M&C modules 102 may also have some internal non-transitory memory to store energy consumption data locally for future transmission in case of a power outage or a transmission malfunction between it, and the DC&DC appliance 104.

The DC&DC appliance 104 is an “always on” device with 24/7 Internet access through an Ethernet or any other high speed/high bandwidth technology. It may consist of a tablet computer in a home setting, or a secure and restricted device in an industrial setting.

The DC&DC appliance 104 serves two functions in one example non-limiting implementation: Its primary function is to collect energy use data from individual M&C modules 102, ideally through a high speed/high bandwidth wireless technology, to store that data in computer memory locally, or on a network attached storage (NAS), as well as to transmit that data to a remote website in the “clouds”—in “real time”. Its secondary function is to communicate with, and control, smart devices directly—similar to a programmable universal remote control device that can communicate with multiple entertainment center devices from a single console. The communication and control of individual devices 100 can be programmed through a separate computer or tablet and scripted based on the controllable features and capabilities of each device, then uploaded to the computer memory of the DC&DC appliance 104. The remote control commands issued by the DC&DC appliance 104 go straight to the individual devices, bypassing the need to go through the M&C modules 102. Commands issued to the M&C modules 102 are typically limited to turning a device “On” and “Off”.

FIG. 3B illustrates the flow of information from an example non-limiting DC&DC appliance 104 to a Universal Data Collection, Control, Analytics, and Community (“UCC”) website 106 “in the cloud” as well as how information stored in the UCC website can be accessed from any web-enabled computing device anywhere in the World.

In the example non-limiting implementation, the UCC Website 106 has four primary functions; its primary function is to collect metering and other information from a multitude of users across the World through their DC&DC appliances 104 and make that data available to them from any web-enabled device, anywhere, anytime. Its secondary function is to allow authorized users to issue commands from any web-enabled device to their respective DC&DC appliances 104 in order to modify the operating schedule or to issue direct commands to specific appliances connected to their respective DC&DC appliance. The third function of the UCC Website 106 is to organize the metering and other data collected from a plurality of participating home owners and organizations into organized tables and charts and to rank participating homes and businesses, anonymously, based on a multitude of criteria. Anonymity can be achieved by enabling users to select identifying handles for their facilities that only they can recognize. The fourth example function of the UCC website 106 is to provide participating energy users, vendors, and utilities with a common place where they can share case studies, discuss new technologies, energy offering from participating utility companies, as well as exchange ideas, knowledge, and experience.

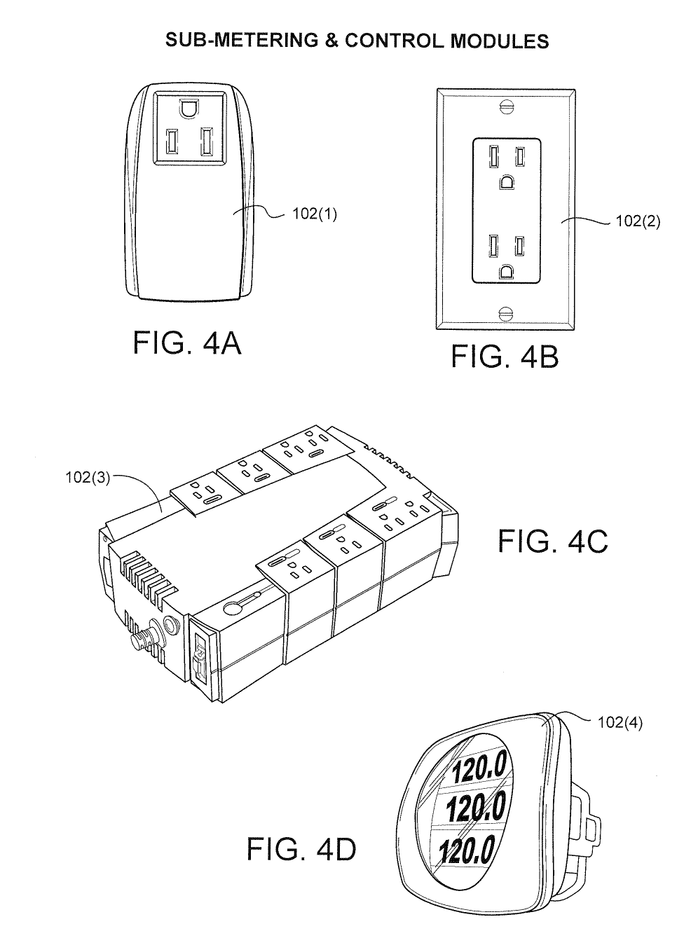

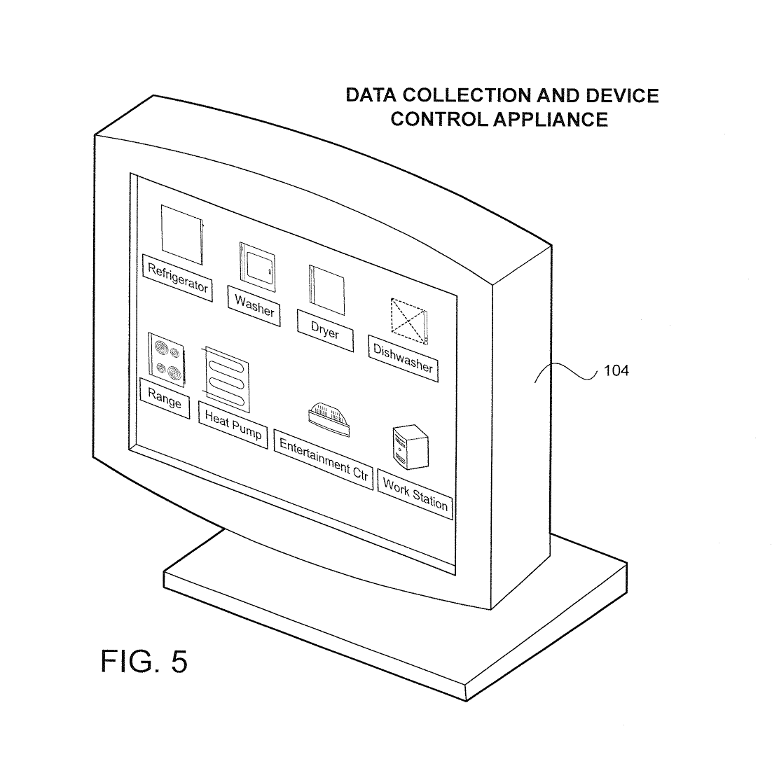

FIGS. 4A-4D illustrate various possible non-limiting embodiments for conventional Sub-Metering and Control modules 102. M&C Modules 102 may be stand-alone, fitted in a wall outlet, combined in a power strip that may or may not have Uninterruptible Power Supply (UPS) capabilities, or may consist of industrial strength modules with display panels for major equipment. Suitable system components include the Shark 100S/200S and Shark MP200 sub-meters sold by Electro Industries/Gaugetech. See Publication Nos. E145722031113V1.11 and 082113E166704V.1.03, incorporated by reference.

The technology of the meters and sub-meters for use as Metering and Sub-metering & Control (M&C) Modules are currently available from Electro Industries/GaugeTech (www.electroind.com). Specifically, the Shark MP200 would represent an ideal solution for the metering concept, it provides for the metering and sub-metering of eight 3-phase and 24 single-phase circuits in one unit using as single CPU and has 32 Megabytes of internal memory for energy usage trending. It also has Ethernet and WiFi capabilities and can profile energy usage trending for steam and gas consumption as well as electricity. For individual metering, Electro Industries provides the Shark 100S and 200S sub-meters with WiFi Ethernet capability.

FIG. 5 illustrates a possible example non-limiting embodiment for a DC&DC appliance 104. Other embodiments may consist of a wall-mounted tablet, a mobile tablet with wireless capabilities and software, a smart phone, or any other computing device with a display, input capabilities and suitable connectivity.

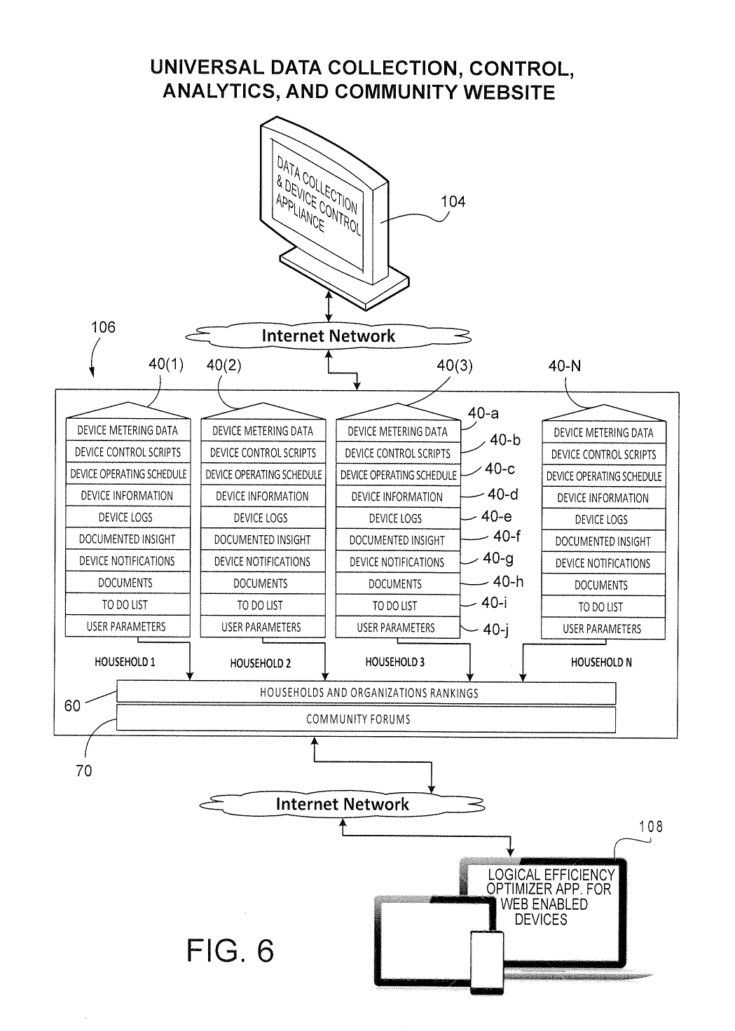

FIG. 6 focuses primarily on the UCC website (106). It illustrates how the displayed data can be compartmentalized by participating household or facility 40(1), 40(2), 40(3), 40(N), and how the data for each participant may be further compartmentalized by type of data and function. For example, in certain embodiments, the data base for each participant may include: (40-a) the data storage for each connected M&C module 102; (40-b) the control scripts for connected devices, appliances, and equipment (“devices”) 100; (40-c) the operating schedules of connected devices; (40-d) devices' manufacturer information and design operating parameters; (40-e) device users' operations logs; (40-f) a storage location for users' notes and documented insight; (40-g) a storage location for possible device automated notifications; (40-h) a location for users to upload relevant documents such as utility bills, energy purchase contracts, etc.; (40-i) a storage location for “To-Do” lists; (40-j) users' parameters, such as location, account settings, access rights, privacy configurations, and other related parameters. The figure also illustrates the inclusion of a household and organizations rankings database (60), and community forums (70).

FIG. 6 also illustrates a “Logical Efficiency Optimizer” or (“LEO”) App 108 to be described in more detail below. This LEO app 108 can run on the same or different appliance as DC&DA 104. It provides a local efficiency optimizer application for web enabled devices that allows a user to for example determine how to more efficiently utilize energy.

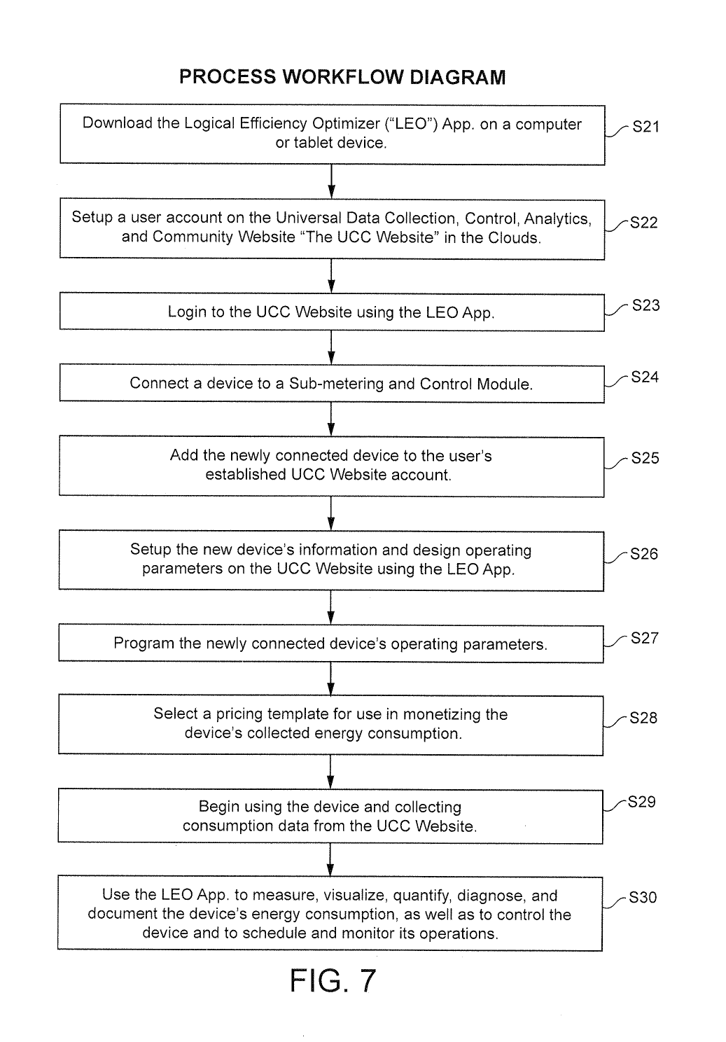

FIG. 7 is a schematic flow diagram of the process involved in connecting a device, appliance, or equipment 100 to an M&C module 102, establishing an account on the UCC website 106, and beginning to monitor and control the attached device from a web-enabled computing device using a specialized application (“App”) which from here on out, will be referred to as the “Logical Efficiency Optimizer” or (“LEO”) App 108. The steps in FIG. 7 include: (S21) Download the Logical Efficiency Optimizer (“LEO”) App. 108 on a computer or tablet device; (S22) Setup a user account on the UCC website in the buds; (S23) Login to the UCC Website using the LEO App.; (S24) Connect a device to an M&C Module; (S25) Add the newly connected device to the user's established UCC Website account; (S26) Setup the new device's information and design operating parameters on the UCC Website using the LEO App.; (S27) Program the newly connected device's operating parameters; (S28) Select a pricing template for use in monetizing the device's collected energy consumption; (S29) Begin using the device and collecting consumption data from the UCC Website; (S30) Use the LEO App. to measure, visualize, quantify, diagnose, and document the device's energy consumption, as well as to control the device and to schedule and monitor its operations.

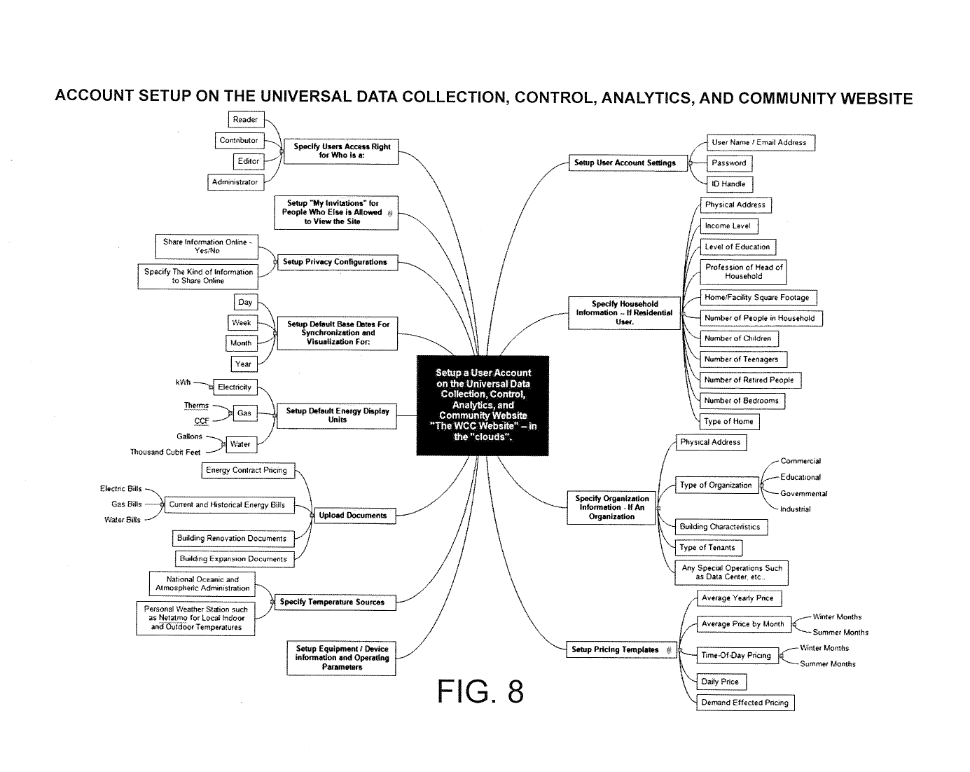

FIG. 8 illustrates a non-limiting example overview of data types that may be collected and the type of settings that may be established during a new account setup on the UCC website 106. Such example functionality includes for example setting up a user account on the universal data collection, control, analytics and community website 106 that may be in the cloud, connected by a network such as the Internet, or the like. Such setup may include for example specifying users access rights (reader, contributor, editor, administrator); setup “my invitations” for who else is allowed to view the site; setup privacy configurations (able to share information online, specification of the kind of information to share online); setup default based dates for synchronization and visualization for day, week, month, year; setup default energy display units for electricity, gas, water and other; setup user account settings such as user name/email address, password, ID handle; specify household information for residential users such as physical address, income level, level of education, profession or job of head of household, home/facility square footage, number of people in household, number of children, number of teenagers, number of retired people, number of bedrooms, type of home; specify organization information if an organization or enterprise (e.g., type of organization such as commercial, educational, governmental or industrial; building characteristics, type of tenants, any special operations such as data center, etc.); setup pricing templates (e.g., average annual or yearly price, average price by month divided seasonally such as winter/summer); time of day pricing (seasonally); daily price; demand effected pricing); setup equipment/device information and operating parameters; specify temperature sources (e.g., NOAA, Personal weather station), and an ability to upload electronic documents (e.g., current and historical electric, gas and water bills; building renovation documents, building expansion documents, etc.

FIG. 9 illustrates a non-limiting example embodiment of main sections of a user interface associated with LEO application 108. The example non-limiting LEO interface consists of five main sections: A Data Center (100), a Selection Panel (200), a Display Panel (300), a Knowledge Center (400), and a Control Center (500). The Data Center (100) is a robust modular platform with full energy data management functionality. Its main function is to list the data sources being monitored by the LEO application. Data sources are separated by sectional tabs into various categories. The Selection Panel (200) enables users to select a device's current or recent energy consumption data and the desired baseline data over which it needs to be compared as well as the viewing period over which the comparison needs to be performed. The Display Panel (300) provides a tabbed viewing area for the visualization, quantification, and monetization of selected data as well as a working area for device control, scheduling, scripting and planning. The knowledge center (400) provides instant access to various components that help users determine what is driving their energy use and cost and helps diagnose and document energy consumption. The Control Center (500) provides instant access to components that help users directly control, schedule, program and plan the operations of individual devices.

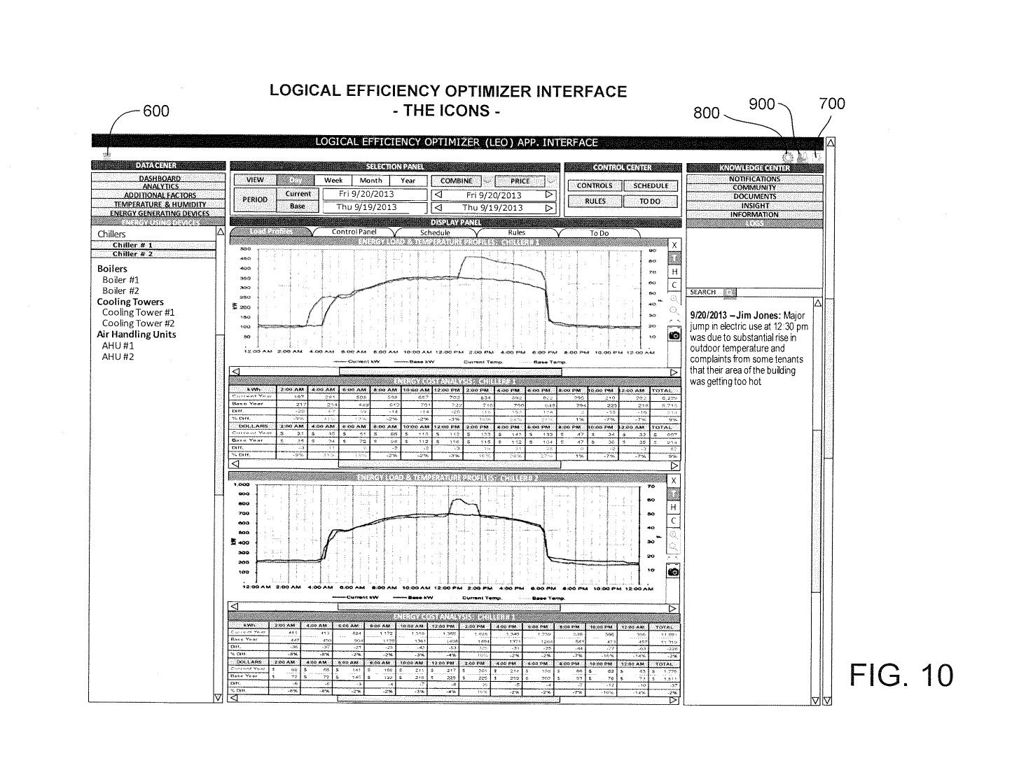

FIG. 10 illustrates a non-limiting embodiment of the use of strategically located icons in the example non-limiting LEO App. that help control the user's viewing experience and provides access to the account setup area of the UCC website. The icon on the upper left area (600) and the icon on the upper right area (700) enable users to show and hide the Data Center and the Knowledge Center sections of the website respectively, on mobile devices. The gear icon (800) provides users with a direct link to the user's account settings on the UCC website. The “people” icon (900) enables users to log on and to log off the UCC website.

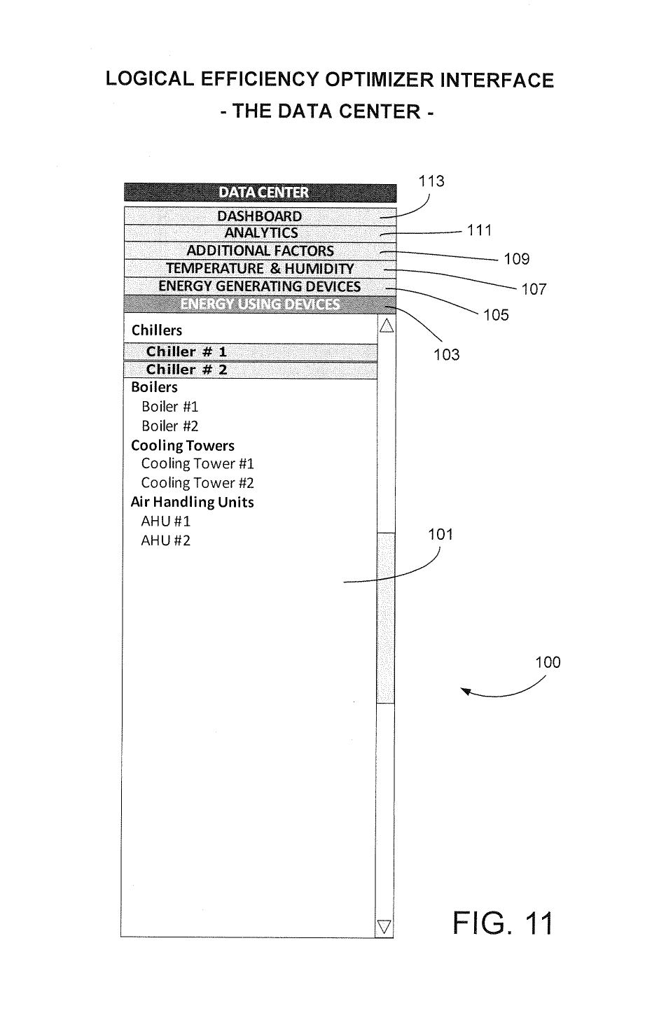

FIG. 11 illustrates a non-limiting example of the various components that may be part of the Data Center (100). The sectional tabs (103-113) categorize various data sources that can be displayed and analyzed by the LEO App. When a user clicks on one of the sectional tabs, the tab located right beneath it automatically slides down to the bottom of the rectangular area of the Data Center (100) and the area that just opened up between the two tabs lists the devices or reports that are available within that category. For example, the Energy Using Devices (103) category, will list all the energy using devices that are available for viewing and control within the LEO App. Clicking on one of the listed devices will display its corresponding energy consumption graph and data in the Display Panel (300) of the website. Clicking on additional listed devices will display their consumption data in the Display Panel (300) area of the LEO interface—one after another—in a vertical fashion.

The Energy Generating Devices (105) category will list energy generating devices which may include solar thermal panels and solar electric panels which convert sun rays into energy. The Temperature and Humidity (107) category will list temperature sources that may include data from the National Oceanic and Atmospheric Administration (NOAA) or weather data from personal weather stations such as the Netatmo wireless station for mobile and computing devices (www.netatmo.com) which provides on-location weather information for indoor and outdoor temperatures. The Analytics (111) category may tabulate the combined monthly performance data of all connected devices, and the Dashboard (113) category may provide aggregated energy performance data by type of utility.

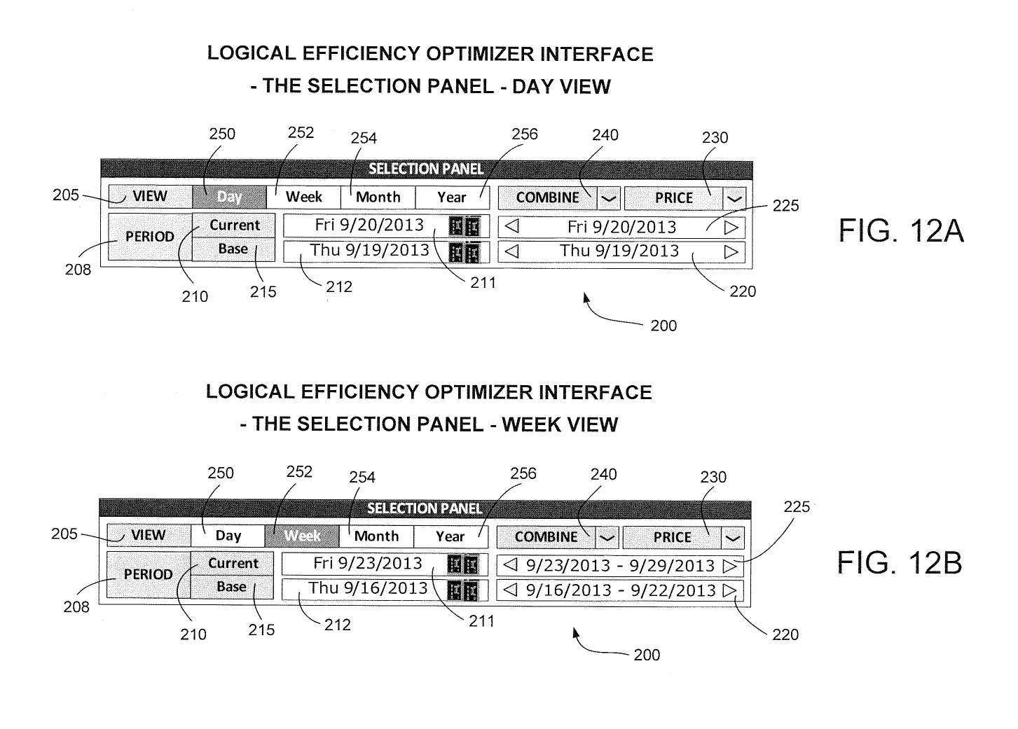

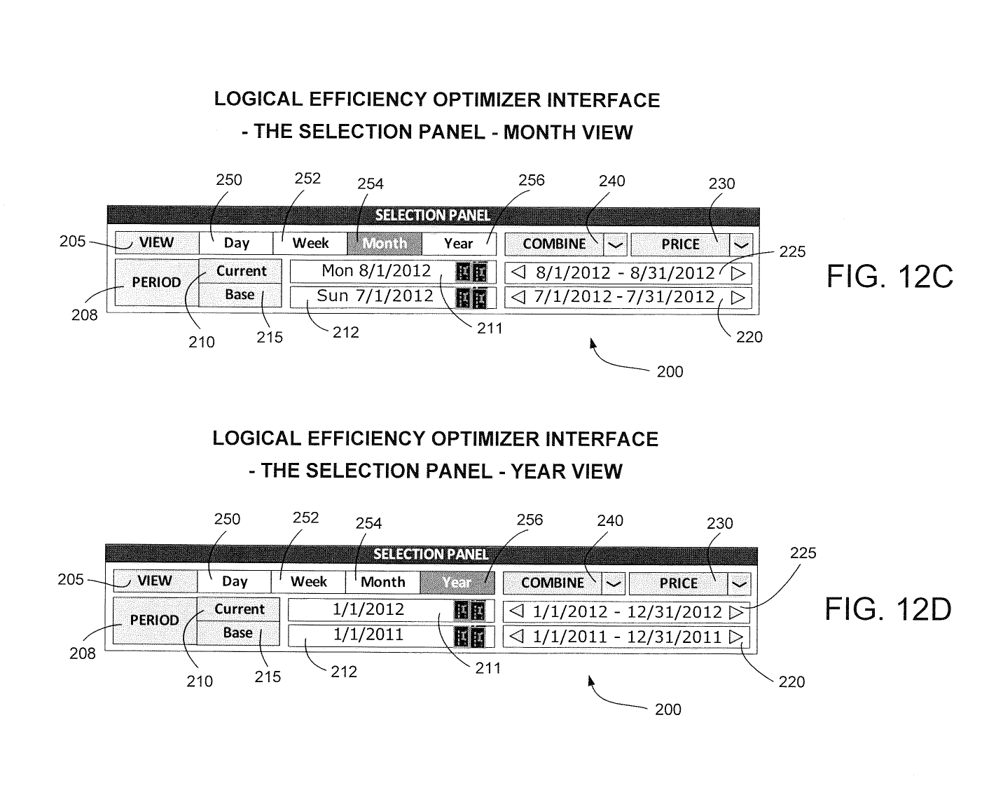

FIG. 12A-12-D illustrate the various components of the Selection Panel (200) for a Day view, Week view, Month view, and Year view. The View (205) area enables users to select the period over which to display the data; Day (250), Week (252), Month (254), or Year (256). The Period (208) area enables users to select the first day of the period of the device's current or recent energy consumption data (211) as well as the period of the first day of the desired baseline data (212) over which the data needs to be compared. The “symbol” on the right side within the selection areas 211 and 212 represent a calendar icon which, when clicked, opens up an small interactive “pop up” calendar to enable users to select the desired dates simply by clicking on them within the pop-up calendar. The display area 225 displays the full date range of the device's selected current or recent energy consumption data, and the display area 220 displays the full date range of the device's selected baseline energy consumption data. For example, in the Day view, the first day of the desired current or recent energy consumption data (211) will be the same as the date displayed in the display area 225. However, in the Week view (252), Month view (254), and Year (256) view, the display areas 225 and 220 will display the date range for each of the selected week, month, and year period respectively.

The “Combine” pull-down menu (240) provides users the option of combining the energy profiles of selected devices in the Display Panel area, or to combine all of the energy profiles of the devices displayed in the Display Panel area, or simply to combine the energy profiles of all Energy Using Devices listed in the Data Center, or all of the Energy Generating Devices listed in the Data Center, or the net combination of the energy profiles of all Energy Using Devices and Energy Generating Devices.

When the “Price” pull-down menu (230) is selected it provides users the option of selecting one of a number of pre-defined pricing templates stored in the UCC website for use in monetizing the selected current and recent energy consumption data and its corresponding baseline data. Pricing templates may consist simply of an average yearly price, an average price by month of year, or an average price per season (winter versus summer); they may be structured by time-of-day, and they may also be structured to include kW demand pricing, or they may be structured in any other way the user defines.

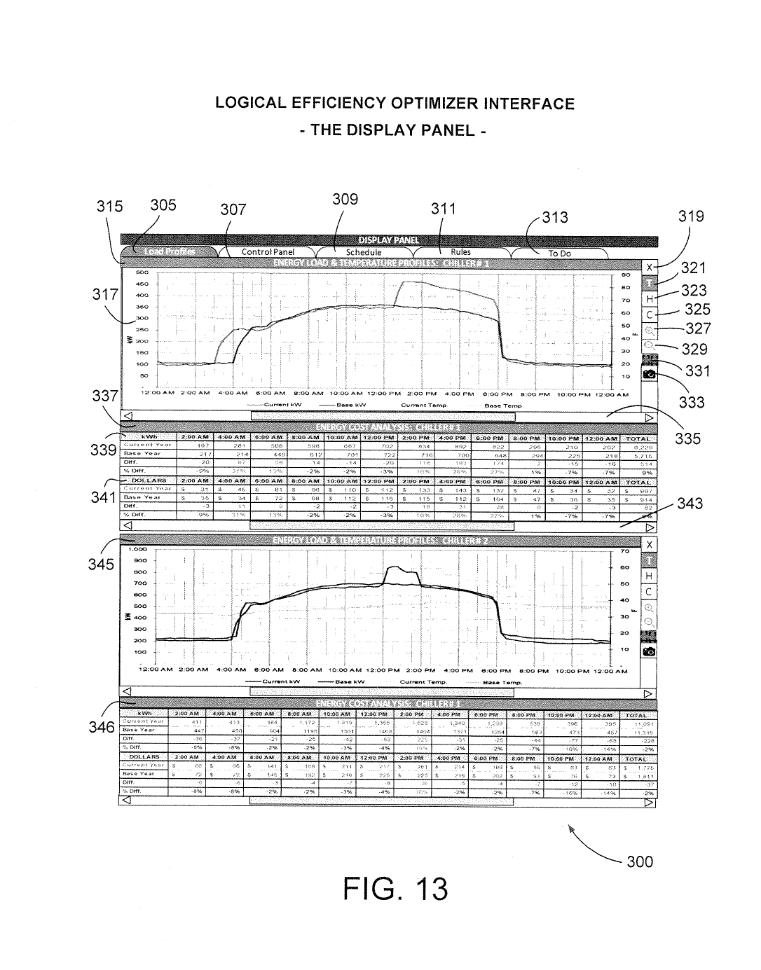

FIG. 13 illustrates the various components of the Display Panel (300). The display panel is tabbed to enable users to switch instantly from one viewing area to another. The default tabbed viewing area is the Load profiles (305) area which is used to display the load profiles and the energy use and cost data of devices selected from the Data Center (100). The other tabbed viewing areas typically display control (307), scheduling (309), automation scripting (311), and planning (313) panels representing the various selection options provided under the Control Center (500).

The Load profiles (305) area displays templates for combined data visualization, quantification, and monetization for each device selected from the Data Center (100). Templates for selected devices as stacked vertically in the same order in which they are selected in the Data Center (100). Each device template consists of three sections; a visualization component (317), a quantification component (339), and a monetization component (341). The visualization component (317) can be acted upon and manipulated through various buttons on the right side of the panel. Clicking the “T” button (321) superimposes corresponding temperature profiles from the selected temperature and humidity category (107) of the Data Center (100). Clicking the “H” button (323) superimposes corresponding humidity profiles from the selected temperature and humidity category (107) of the Data Center (100). Clicking on the “C” button (325) selects the visualization template for combination with other templates in the display panel when acted upon using the “Combine” (240) button of the Selection Panel (200). Clicking the “+” magnifying button (327) results in the template “zooming in” on the data and displaying it with greater granularity with each click of the button; for example, consumption data displayed in 2-hour increments, may be displayed in 1-hour increments after 1 click of the button, and in 30-minute increments with another click of the button, and so on. Furthermore, every click of the magnifying button (327) will also result in the data displayed in the quantification component (339) and the monetization component (341) matching the increased granularity of the data displayed in the visualization component (317). Therefore, if the data displayed in the visualization component (317) expands from 2-hour increments to 1-hour increments, the corresponding data in the quantification (339) and monetization (341) components will also expand from 2-hour increments into in 1-hour increments. Since the display area may reflect only 12 divisions of the hourly data, the remaining data may be viewed by using the sliders at the bottom of the monetization component (341). The “−” magnifying button (329) does the reverse opposite of the actions described for the “+” magnifying button (327). The expansion button (331), when pressed, will expand the graphic area to fill the entire screen of the computing device. This can be undone by pressing the “esc” button or a similar type of button. The camera button (333) will issue a command to print the graphic and numerical data displayed in the visualization (317), quantification (339) and monetization (341) components of the selected device's display template. The “X” button (319) will close the display template of the selected device and move any other template located below the closed template such as template (345) upward.

It is worth noting in this respect, that when used on a touch-enabled computing device, one can move the devices' displayed templates upward or downward simply by placing a finger on a display panel and moving or flicking the finger upward or downward in a vertical fashion. Furthermore, by placing a finger on the display area (317) of a display template (315) and moving the finger left or right, one can change the period of the data displayed on the display template (315) from one period to the next, or from one period to a prior period. If the displayed data is in the Day view (250), the display period will change to the prior or to the following day; if the displayed data is in Week view (252), the display period will change to the prior or to the following week; if the display data is in Month view (254), the display period will change to the prior or to the following week, etc. It is worth noting in this respect, that when the display period changes from one period to the next, the time difference between the selected current or recent energy consumption and the selected base energy consumption will remain the same across changing periods.

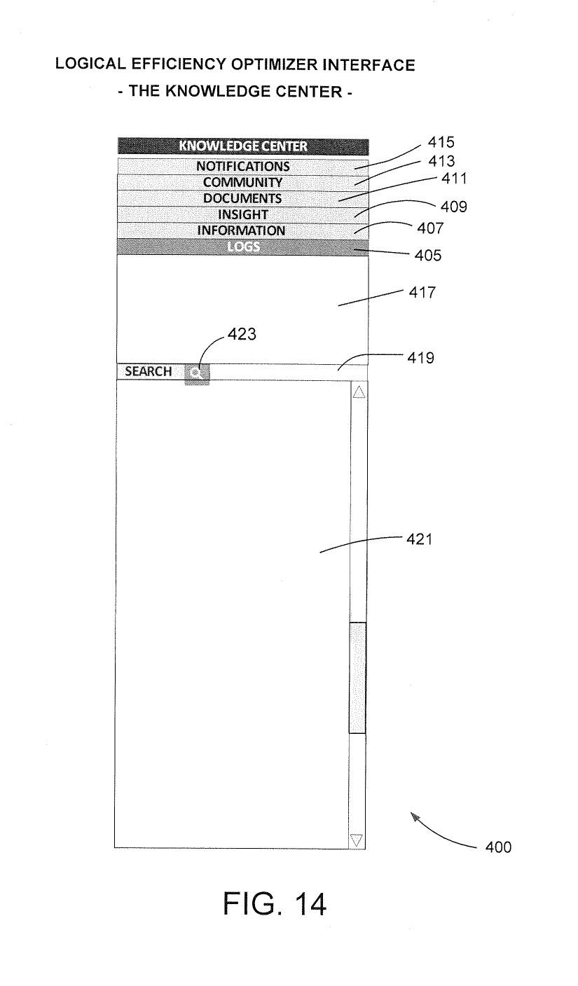

FIG. 14 illustrates a non-limiting example of the various components that may be part of the Knowledge Center (400). The sectional tabs (415-421) categorize various knowledge components that contextualize the visual and tabular information displayed in the Display templates (315, 345, etc.) and turn them into insight. When a user clicks on one of the sectional tabs, the tab located right beneath it automatically slides down to the bottom of the rectangular area of the Knowledge Center (400) and the area that just opened up between the two tabs lists the information or options that are available within that category. The Logs category (405) displays interactive operating logs that corresponds to the clicked Display template (315, 345, etc.) that is displayed in the Display Panel (300). Users, or facility operating personnel, may enter information into the comments input area (417) and their comments may instantly be stamped by the date and time of entry and the user's long-in handle and displayed in the comments display area (421) of the Logs (405) category. To view earlier comments, users may scroll the comments display area (421) up and down, or search on a particular word or subject in the log's search area (419). As mentioned above, each listed device will have its own “operations log” which may be accessed by clicking on the listed device in the Data Center (100) or by clicking the device's displayed display template (315, 345, etc.) in the Display Panel (300). The information category (407) of the Knowledge Center (400) operates in the same fashion, except this category is for documenting a device's “nameplate information”; its make, model, power rating, etc. . . . as well as its optimum design operating parameters. It is meant to eliminate the need for operating manuals and training, especially in commercial and industrial environments. The Insight category (409) is an area for recording learned knowledge and actionable insights in general; a sort of energy “wiki” for home and commercial organizations. The Documents category (411) may be an area for storing home or building utility bills, equipment warranties, pricing contracts, and other energy use, price, and cost related documents that may be of interest to the user. The Community category (413) provides links and possibly a feed from the community website which may be an aspect of the UCC website described above. The website may provide user rankings (as described above), and additional areas for forums, case studies, a vendors' corner, and a place for special utility commodity offers. The Notifications category (415) may be an area for the storage of automated “smart” equipment notifications. An area where automated notifications related to equipment exceeding specified operating parameters, or encountering mechanical or electronically problems, may displayed.

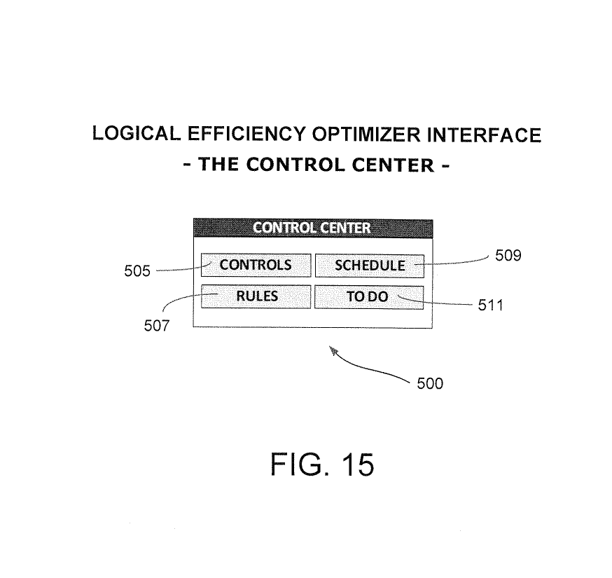

FIG. 15 illustrates the various components of the Control Center (500). The Controls button (505) activates the control panel tab (307) of the Display Panel (300). The Control Panel (307) provides an area where commands to individual devices may be sent remotely from the LEO App. The Rules button (507) activates the “Rules” tab (311) of the Display Panel (300). The Rules tab provides an area where automation scripts for individual devices may be scripted and combined in a fashion that would trigger a sequence of events when certain conditions are realized. For example, in an industrial setting, when the outdoors temperature has reached a certain temperature, action control scripts may activate to shut down or modify the behavior of multiple pieces of equipment. In a home environment, action control scripts that may control the light and sound equipment of the home may activate when a specific car pulls into the garage. The Schedule button (509) activates the Schedule tab (309) which provides a calendar for the automated scheduling of the operations activity of certain equipment or devices or for running certain action control scripts. In addition, to its calendaring capability, the scheduling function of the Schedule button (509) provides an excellent system for analyzing the operating performance of specific equipment in light of their scheduled operating profile in the Schedules panel (309). The ToDo button (511) activates the To Do tab (313) of the Display Panel (300) and enables users to schedule and plan human activities, such as changing filters, replacing light bulbs, or planning commodity bids for expiring gas or electricity contracts (in a commercial environment), etc.

FIG. 16 provides close-up visual examples of the synchronization, visualization, quantification, and monetization methods for analyzing the operating performance of a device in 2-hour increments.

A. Synchronization & Visualization Method:
Current or Recent Day=Any Day or Date of the Year.
Base Day=Any Day or Date of the Year.
Current or Recent Day Start Time=Any Time of the Day.
Base Day Start Time=Any Time of the Day—But Must Be Synchronized with the Start Time of the Chosen Current or Recent Day.

B. Quantification Method:
Compute the amount of energy used in the specified time increments for the whole 24-hour period, separately, for the Current or Recent Day as well as the Base Day.
Compute the difference in the amount of energy used per specified time interval between the select Current or Recent Day, and the Base Day.

C. Monetization Method:
Select a pricing template from the templates setup during the initial account setup. Typically, a representative average $/kWh or $/Energy figure is selected. Although in some instances a template mimicking the actual rate schedule that is applied by the utility company may be used.
Multiply the amounts of energy used in the visualized time intervals by the pricing parameters of the chosen pricing template to derive the actual cost per visualized time interval.

FIG. 17 provides close-up visual examples of the synchronization, visualization, quantification, and monetization methods for analyzing the operating performance of a device in 1-hour increments.

A. Synchronization & Visualization Method:
Current or Recent Day=Any Day or Date of the Year.
Base Day=Any Day or Date of the Year.
Current or Recent Day Start Time=Any Time of the Day.
Base Day Start Time=Any Time of the Day—But Must Be Synchronized with the Start Time of the Chosen Current or Recent Day.

B. Quantification Method:
Compute the amount of energy used in the specified time increments for the whole 24-hour period, separately, for the Current or Recent Day as well as the Base Day.
Compute the difference in the amount of energy used per specified time interval between the select Current or Recent Day, and the Base Day.

C. Monetization Method:
Select a pricing template from the templates setup during the initial account setup. Typically, a representative average $/kWh or $/Energy figure is selected. Although in some instances a template mimicking the actual rate schedule that is applied by the utility company may be used.
Multiply the amounts of energy used in the visualized time intervals by the pricing parameters of the chosen pricing template to derive the actual cost per visualized time interval.

FIG. 18 provides close-up visual examples of the synchronization, visualization, quantification, and monetization methods for analyzing the operating performance of a device in weekly increments.

A. Synchronization & Visualization Method:
1st Day of the Current or Recent Week=Any Day or Date of the Year.
1st Day of the Base Week=Any Day or Date of the Year that is a multiple of 7 of the Chosen 1st Day of the Current or Recent Week. In Other Words, the 1st Day of the Week of the Current or Recent Week and the 1st Base Day of the Week of the Base Week must be the same.
Current or Recent Week Start Time=Any Time of the Day.
Base Week Start Time=Any Time of the Day—But Must Be Synchronized with the Start Time of the Chosen Current or Recent Week.

B. Quantification Method:
Compute the amount of energy used per day, separately, for the Current or Recent Week as well as the Base Week.
Compute the difference in the amount of energy used per day between the select Current or Recent Week, and the Base Week.

C. Monetization Method:
Select a pricing template from the templates setup during the initial account setup. Typically, a representative average $/kWh or $/Energy figure is selected. Although in some instances a template mimicking the actual rate schedule that is applied by the utility company may be used.
Multiply the amounts of energy used in the visualized time intervals by the pricing parameters of the chosen pricing template to derive the actual cost per visualized time interval.

FIG. 19 provides close-up visual examples of the synchronization, visualization, quantification, and monetization methods for analyzing the operating performance of a device in monthly increments.

A. Synchronization & Visualization Method:
1st Day of the Current or Recent Month=The First Day of the Selected Month—With the Data of the 1st Monday of the Month ALWAYS represented between the 7th and the 9th POSITION (The Preferred Position) on a 42-Day Monthly Graph (Which Encompasses 6 Weeks).
1st Day of the Base Month=The First Day of Any Selected Month—With the Data of the 1st Monday of the Month ALWAYS represented between the 7th and the 9th POSITION (The Preferred Position) on a 42-Day Monthly Graph. However, the Location of the first Monday of the Base Month, Must Always Match the Location of the Current or Recent Month.
Current or Recent Month Start Time=Any Time of the Day.
Base Month Start Time=Any Time of the Day—But Must Be Synchronized with the Start Time of the Chosen Current or Recent Month.

B. Quantification Method:
Compute the amount of energy used per day, separately, for the Current or Recent Month as well as the Base Month.
Compute the difference in the amount of energy used per day between the select Current or Recent Month, and the Base Month.

C. Monetization Method:
Select a pricing template from the templates setup during the initial account setup. Typically, a representative average $/kWh or $/Energy figure is selected. Although in some instances a template mimicking the actual rate schedule that is applied by the utility company may be used.
Multiply the amounts of energy used in the visualized time intervals by the pricing parameters of the chosen pricing template to derive the actual cost per visualized time interval.

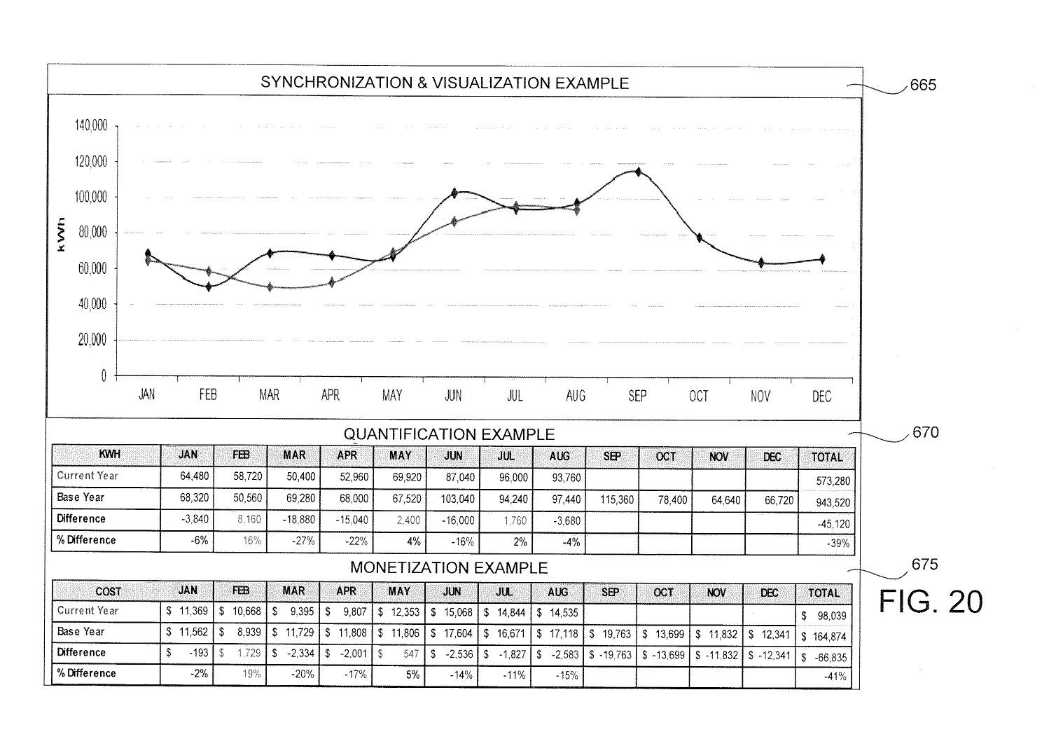

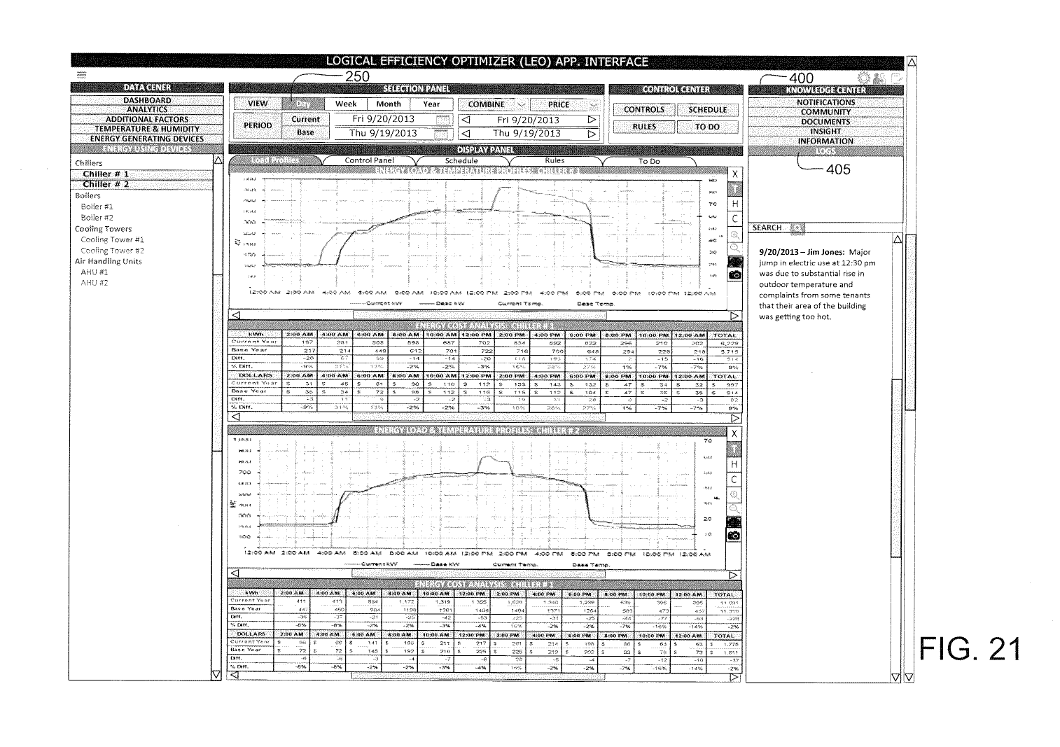

FIG. 20 provides close-up visual examples of the synchronization, visualization, quantification, and monetization methods for analyzing the operating performance of a device in yearly increments.

A. Synchronization & Visualization Method
1st Month of the Current or Recent Year=Any Month of the Year.
1st Month of the Base Year=Any Month of the Year—As Long as it is a Multiple of 12 of the Chosen 1st Month of the Current or Recent Year. In Other Words, the 1st Month of the Current or Recent Year and the 1st Month of the Base Year Must be the same.
Current or Recent Year Start Time=Any Time of the Day.
Base Year Start Time=Any Time of the Day—But Must Be Synchronized with the Start Time of the Chosen Current or Recent Year.

B. Quantification Method:
Compute the amount of energy used per month, separately, for the Current or Recent Year as well as the Base Year.
Compute the difference in the amount of energy used per month between the select Current or Recent Year, and the Base Year.

C. Monetization Method:
Select a pricing template from the templates setup during the initial account setup. Typically, a representative average $/kWh or $/Energy figure is selected. Although in some instances a template mimicking the actual rate schedule that is applied by the utility company may be used.
Multiply the amounts of energy used in the visualized time intervals by the pricing parameters of the chosen pricing template to derive the actual cost per visualized time interval.

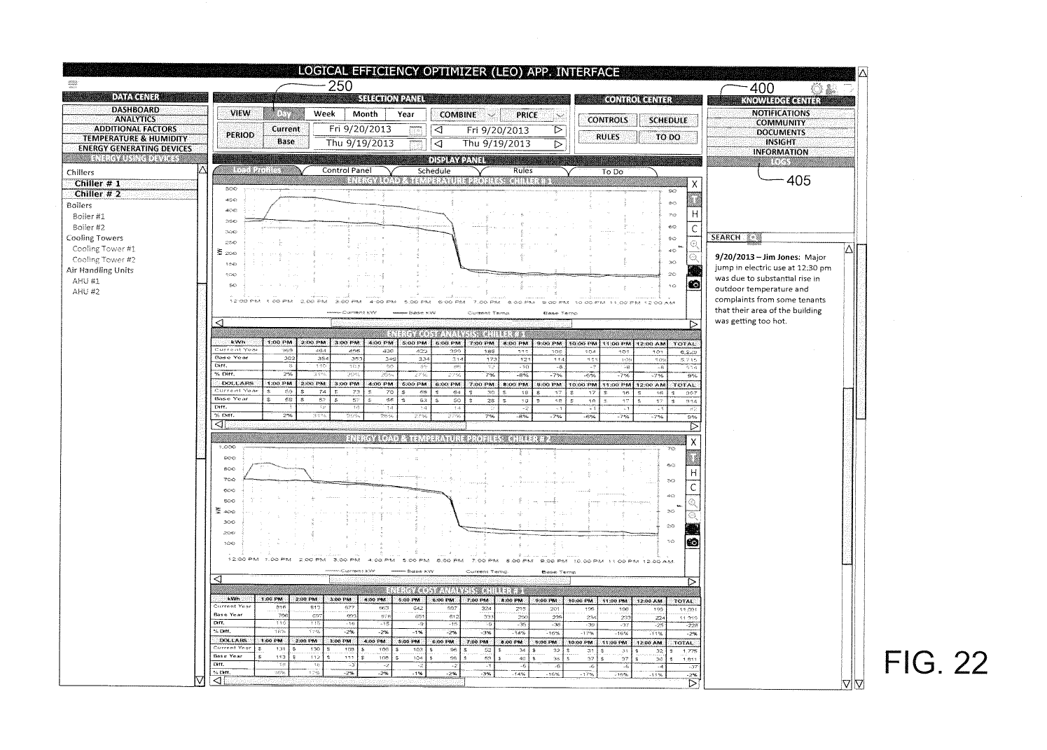

FIG. 21 provides an example non-limiting view of the LEO App. interface illustrating selected devices load profiles in Day (250) view, visualized in 2-hour increments, and displaying a log entry in the Logs (405) category of the Knowledge Center (400).

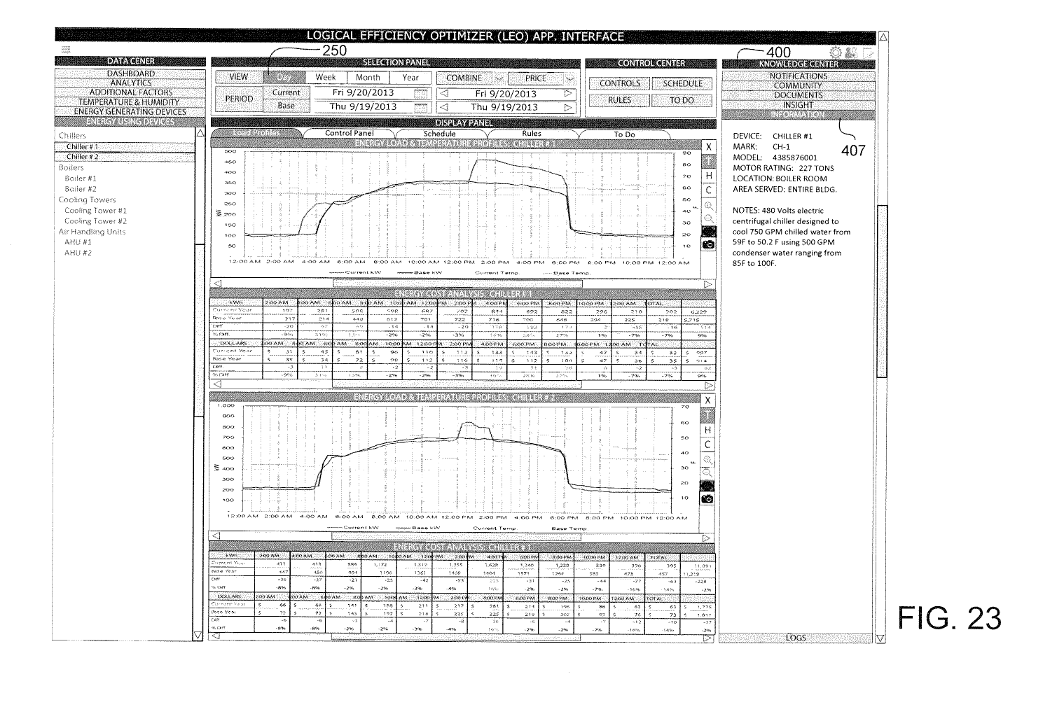

FIG. 22 provides an example non-limiting view of the LEO App. interface illustrating selected devices load profiles in Day (250) view, visualized in 1-hour increments, and displaying a log entry in the Logs (405) category of the Knowledge Center (400).

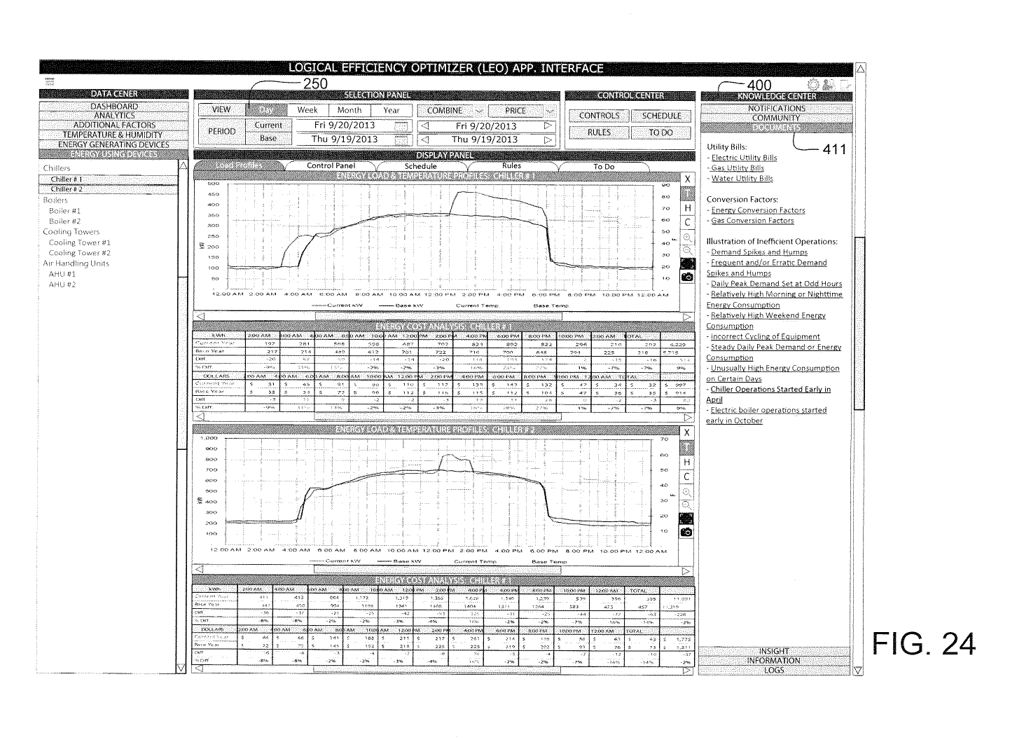

FIG. 23 provides an example non-limiting view of the LEO App. interface illustrating selected devices load profiles in Day (250) view, visualized in 2-hour increments, and displaying device information in the information (407) category of the Knowledge Center (400).

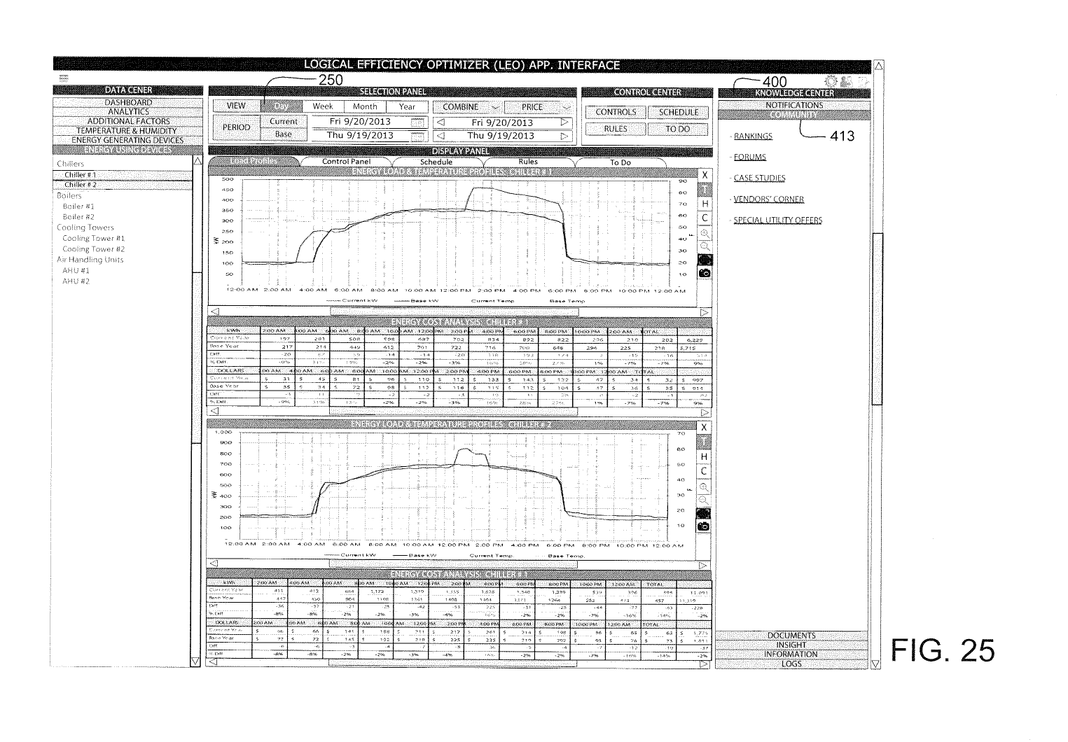

FIG. 24 provides an example non-limiting view of the LEO App. interface illustrating selected devices load profiles in Day (250) view, visualized in 2-hour increments, and displaying document links in the Documents (411) category of the Knowledge Center (400).

FIG. 25 provides an example non-limiting view of the LEO App. interface illustrating selected devices load profiles in Day (250) view, visualized in 2-hour increments, and displaying links in the Community (413) category of the Knowledge Center (400).

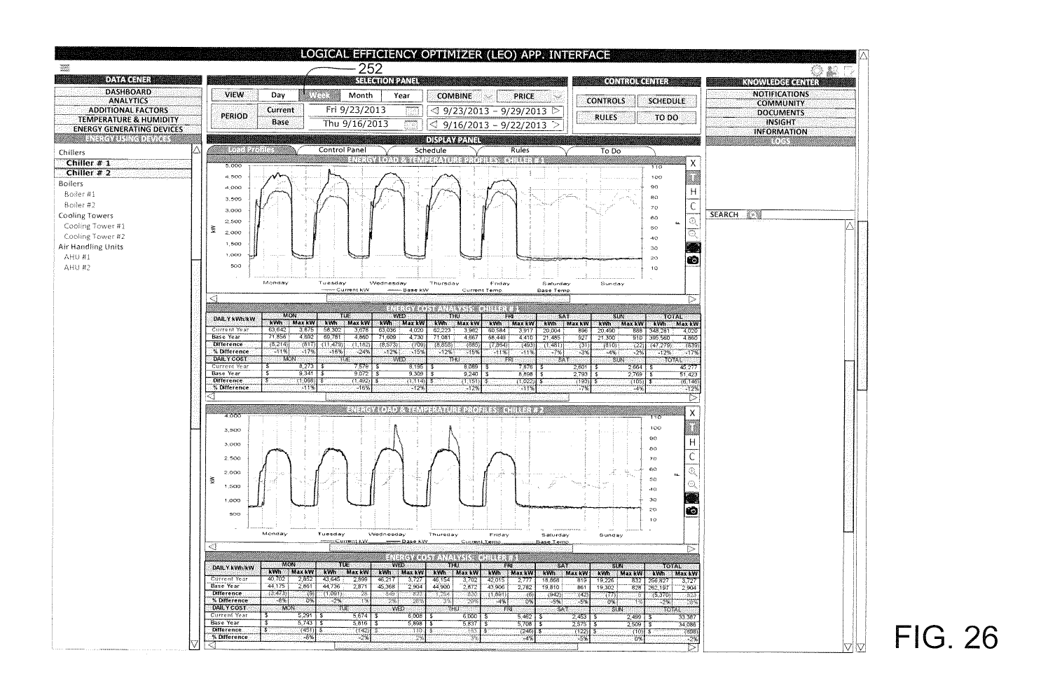

FIG. 26 provides an example non-limiting view of the LEO App. interface illustrating selected devices load profiles in the Week (252) view.

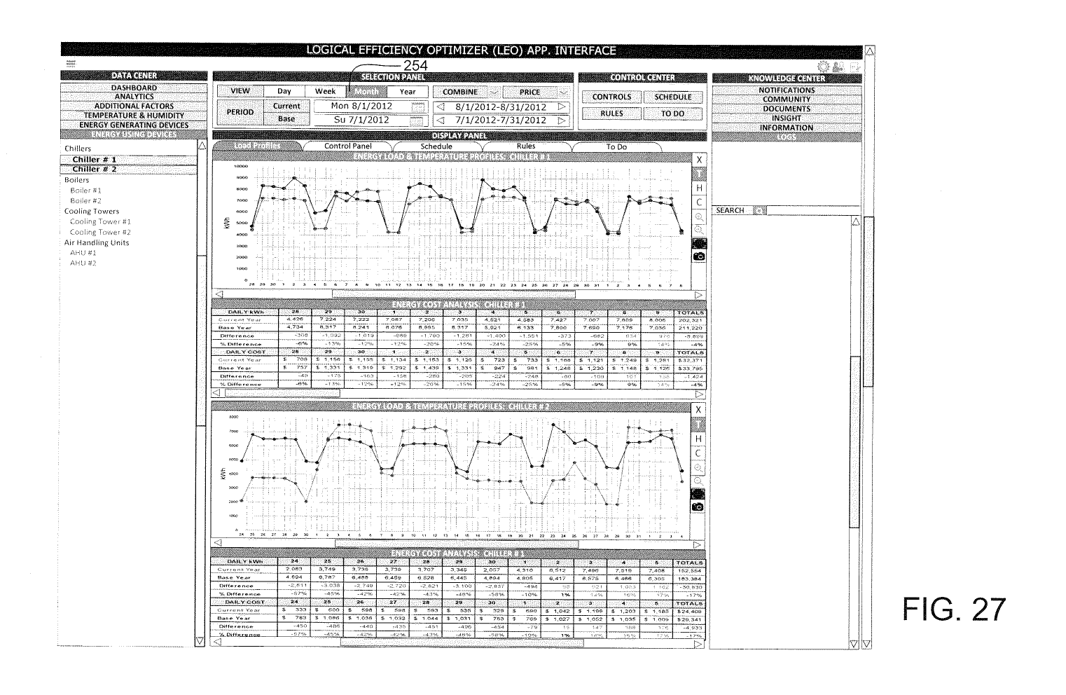

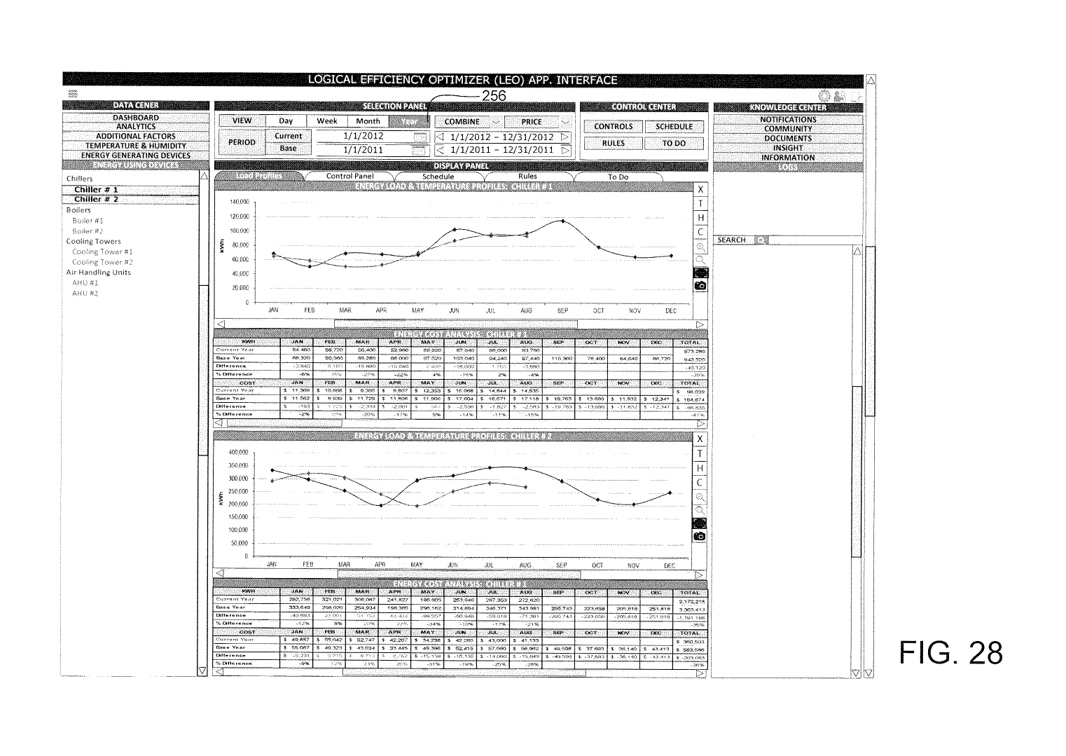

FIG. 27 provides an example non-limiting view of the LEO App. interface illustrating selected devices load profiles in the Month (254) view.

FIG. 28 provides an example non-limiting view of the LEO App. interface illustrating selected devices load profiles in the Year (256) view.

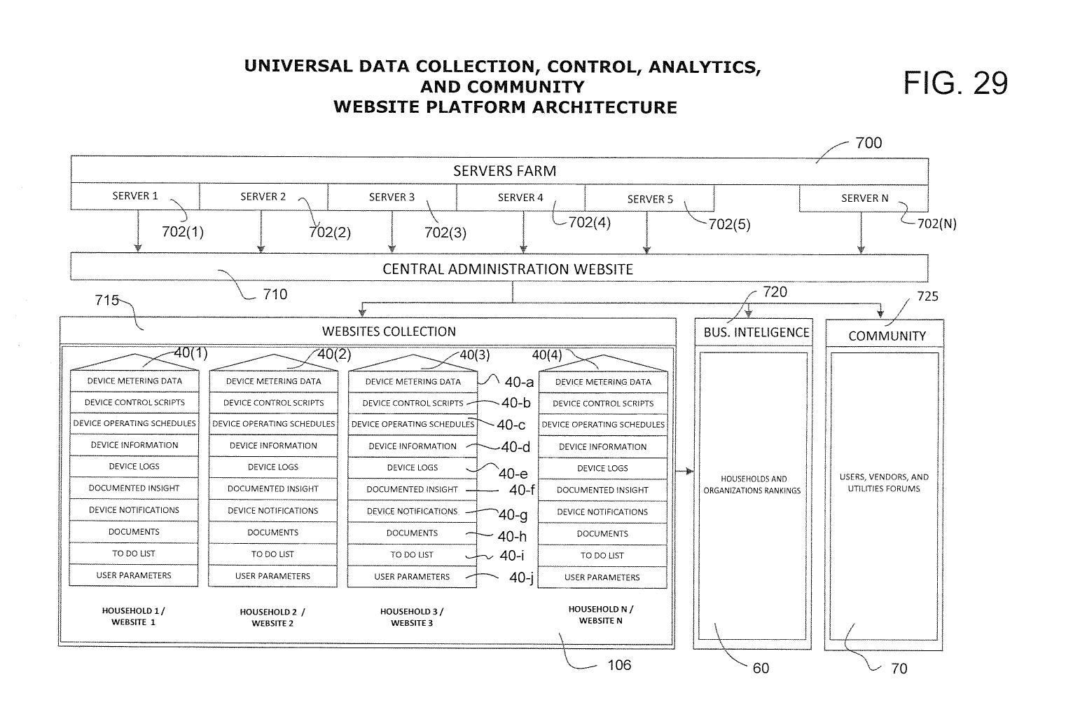

FIG. 29 provides a basic non-limiting example schematic for a SharePoint hosted servers' farm 702(1), 702(2), 702(3), 702(4), 702(5), 702(N), implemented by computers storing executable instructions in non-transitory storage media controlled by a single Central Administration Website (710) in the “clouds” and consisting of a Website Collection component (715), a Business Intelligence component (720), and a Community portal (725). It further illustrates how the data can be compartmentalized by participating household or facility 40(1), 40(2), 40(3), 40(N), and how the data for each participant may be further compartmentalized by type of data and function. The figure also illustrates the inclusion of a household and organizations rankings database (60), and community forums (70).

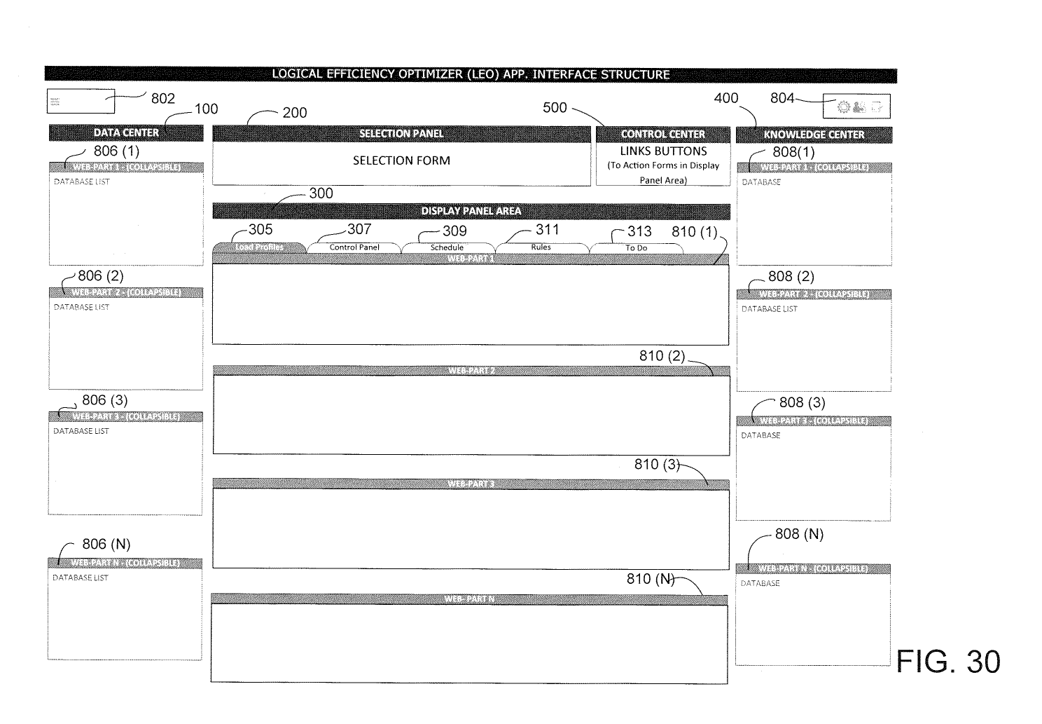

FIG. 30 illustrates the logical components of the LEO interface template. Basically, the Data Center (100) consists mainly of SharePoint web-parts (A web part is a self-contained piece of a web page. It has its own rules, abilities, and behavior. Web parts are modular pieces. They can be very simple, or very complex. They often represent pieces that are elsewhere on the website. Web parts can display data from other sources, such as lists, data, search results, forms, or even another web page. A Web part can be a window to a list or a Library on the website. The web part itself does not have data, it just shows the data.)

The example non-limiting Data Center (100) consists mainly of collapsible web parts that contain the lists of energy using devices, energy generating devices, temperature and humidity sources, etc. The Display Panel Area (300) consists of web parts that combine the above-described synchronization & visualization component with the quantification and monetization components for each data source in the Data Center (100). The Selection Panel (200) consists of a selection form. The Knowledge Center (400) consists of collapsible web parts that include both database lists as well as databases, and the Control Center (500) consists of buttons that provide links to action control forms in the Display Panel Area (300).

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of synchronizing and visualizing commodity usage for a desired time period such as day, week or month comprising:
collecting information relating to usage of a commodity by equipment in predetermined granular time increments;
with a processor, comparing said collected usage information with a select baseline of recent and/or historical usage of the commodity by the equipment; and
displaying, with the processor, a graphical visualization of the comparison showing usage comparison in any selected ones of minute, hour, day, week and/or month increments.

2. The method of claim 1 further including combining synchronization, visualization, quantification, and monetization to transform energy efficiency from an abstract concept to something tangible that anyone can understand and relate to.

3. The method of claim 1 wherein synchronization, visualization, and quantifications are combined with equipment information and operations logs in the Knowledge Center to generate actionable insight.

4. The method of claim 2 further including monetization from a display panel, and actionable insights from a Knowledge Center with direct control and equipment scheduling in the Control Center to quickly re-calibrate and optimize the operations of any device, appliance, or equipment system.

5. A system comprising:
a networked interface that establishes communication with a unit that meters and monitors consumption of a resource by equipment, the networked interface measuring and collecting, in computer memory, usage of the resource by the equipment in specific small time increments;
a processing device coupled to the networked interface, the processing device quantifying the difference in resource use between current or recent resource use and a select baseline from recent or historical resource use data of the equipment, the processing device diagnosing and documenting collected resource usage data based on at least operating parameters and time of operation of the equipment; and
a reprogramming device that reprograms the equipment's operating parameters based at least in part on the diagnosed and documented collected resource usage data.

6. The system of claim 5 wherein the processing device is further configured to integrate synchronization to a baseline, visualization, quantification, monetization, diagnosis, documentation, and taking or scheduling actions to optimize the operating and financial performance of the equipment.

7. The system of claim 5 further including an application configure to use information and logging components of a knowledge center in combination with synchronization and visualization to enable users to diagnose and document energy consumption and cost.

8. The system of claim 7 wherein the application provides integration and the location and workings of each section of that interface.

9. The system of claim 7 wherein the application provides sectional tabs drop down when clicked on to open up new areas.

10. The system of claim 7 wherein the application includes a tabbed display area that integrates displaying the operating and financial performance of each device with quickly controlling and modifying the schedule of the equipment.

11. The system of claim 7 wherein the application is configured to zoom in on the operations and costs of the equipment.

12. The system of claim 7 wherein the application is configured to add and remove performance of the equipment from a display panel.

13. The system of claim 7 wherein the application is configured to scroll the display area vertically to see the operation of various equipment concurrently.

14. The system of claim 7 wherein the application scrolls the graphic area of each device horizontally in web-enabled devices to move from one period to another sequentially.

15. The system of claim 7 wherein the application is configured to selectively hide and show information for web-enabled devices.

16. The system of claim 7 wherein the application is configured to instantly expand the viewing of each graph to fill the whole screen of a display.

17. The system of claim 7 wherein the application integrates a camera icon for printing the graphs to a printer or to a PDF file.

18. The system of claim 7 wherein the application combines the visual performance of select graphs.

19. The system of claim 7 wherein the application superimposes weather and humidity on displayed usage graphs.

20. The system of claim 7 wherein the application is configured to select various weather sources.

21. The system of claim 5 wherein the processing device is configured to provide an analytics module to instantly list and combine the operating and financial performance of various attached equipment in one place.

22. The system of claim 5 wherein the processing device is configured to use price templates to instantly evaluate costs based on various pricing options for forecasting and predicting the energy costs of specific actions and available utility pricing options.

23. The system of claim 5 wherein the processing device is configured to use of a scheduling feature to verify results of actions taken earlier, by correlating an operations schedule with an operations profile.

24. The system of claim 5 wherein the processing device is configured to instantly tally users' consumption data with detailed, anonymized, personal data from their account profiles to generate personalized insights and rankings.
